(19) United States
(12) Patent Application Publication
(10) Pub. No.: US 2017/0243084 A1
(43) Pub. Date: Aug. 24, 2017

(54) DSP-SIFT: DOMAIN-SIZE POOLING FOR IMAGE DESCRIPTORS FOR IMAGE MATCHING AND OTHER APPLICATIONS

(71) Applicant: THE REGENTS OF THE UNIVERSITY OF CALIFORNIA, Oakland, CA (US)

(72) Inventors: Stefano Soatto, Pasadena, CA (US); Jingming Dong, Los Angeles, CA (US)

(73) Assignee: THE REGENTS OF THE UNIVERSITY OF CALIFORNIA, Oakland, CA (US)

(21) Appl. No.: 15/345,373

(22) Filed: Nov. 7, 2016

Related U.S. Application Data
(60) Provisional application No. 62/251,866, filed on Nov. 6, 2015.

(51) Int. Cl. G06K 9/62; G06K 9/46; G06K 9/52

(52) U.S. Cl. CPC G06K 9/6267; G06K 9/52; G06K 9/4642; G06K 2009/4666

(57) ABSTRACT

A variation of scale-invariant feature transform (SIFT) based on pooling gradient orientations across different domain sizes, in addition to spatial locations. The resulting descriptor is called DSP-SIFT, and it outperforms other methods in wide-baseline matching benchmarks, including those based on convolutional neural networks, despite having the same dimension of SIFT and requiring no training. Problems of local representation of imaging data are also addressed as computation of minimal sufficient statistics that are invariant to nuisance variability induced by viewpoint and illumination. A sampling-based and a point-estimate based approximation of such representations are described.

### CROSS-REFERENCE TO RELATED APPLICATIONS

This application is a continuation of U.S. patent application Ser. No. 62/251,866 filed on Nov. 6, 2016, incorporated herein by reference in its entirety.

### STATEMENT REGARDING FEDERALLY SPONSORED RESEARCH OR DEVELOPMENT

This invention was made with Government support under FA9550-12-1-0364, awarded by the U.S. Air Force, Office of Scientific Research. The Government has certain rights in the invention.

### INCORPORATION-BY-REFERENCE OF COMPUTER PROGRAM APPENDIX

Not Applicable

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND

1. Technical Field

The technology of this disclosure pertains generally to image feature extraction, and more particularly to performance improvements to scale-invariant feature transform (SIFT).

2. Background Discussion

Numerous applications exist for extracting one or more “features” from an image(s), then matching those features across time (tracking) for different instances of the same objects (recognition), different object classes (classification), and so forth. For example, the applications include image matching for content-based retrieval, visual recognition, augmented reality, tracking and a large host of other image based applications.

One of the more popular of such feature extraction mechanisms is scale-invariant feature transform (SIFT) which is a computer vision method for detecting and describing local features in images. SIFT is utilized by companies worldwide for applications ranging from automotive driving and robotics, to augmented reality.

Researchers have worked on numerous variations of SIFT, toward increasing its performance and applicability. For instance, companies working in these image processing areas which do not license SIFT itself have developed in-house variants of it. Thus, SIFT or its variants are utilized worldwide. Popular variants or extensions of SIFT, include histogram of oriented gradients (HOG), deformable part models (DPM), and numerous other schemes that use SIFT as a building block. These SIFT variants typically provide meager performance gains.

In visual data a “feature descriptor” is a function of images which optimally should be “insensitive” to nuisance variability while being “discriminative” with respect to intrinsic properties of the scene or the object of interest. Nuisance variability, for instance, may results from viewpoint and illumination changes, and intrinsic properties such as three-dimensional shape and material properties of the scene, or object-specific deformations. However, it has been a struggle toward attaining ideal representations in terms of being “discriminitive”.

Accordingly, a need exists for a more efficient variant of SIFT, and to provide a mechanism for determining the performance of various descriptors. The present disclosure fulfills these needs, and overcomes a number of shortcomings of prior approaches.

### BRIEF SUMMARY

The disclosed technology is a variant of SIFT which is determined from a derivation of first principles of SIFT, that is to say the disclosed technology is derived from the fundamental concepts or assumptions on which the SIFT method was based. In particular, a variant of SIFT is disclosed that provides substantial improvement over average SIFT performance; in some cases by over 30%. It should be noted that this improvement is in a crowded field in which researchers have struggled to reach 2-3% levels of performance improvement with other variants.

Specifically, the disclosed technology adds scale pooling to SIFT, so that information from rescaling of the patch is also aggregated using domain-size pooling (DSP). With the disclosed modification, this new SIFT variant, referred to herein as DSP-SIFT, can surpass the use of convolutional neural networks (CNN) by a large margin.

The disclosed approach is also applicable to numerous other descriptors, thus generating DSP-equivalent of many existing methods, from DSP-HOG, to DSP-DPM, and the like, while convolutional neural networks (CNN) can also be extended.

A second portion of the disclosure describes a method for quantifying how “discriminative” a descriptor is, by characterizing its dependency on intrinsic properties of the scene, namely shape S and reflectance p. To quantify how “insensitive” the descriptor is, the disclosure provides a mechanism for describing its dependency on nuisance factors, such as viewpoint and illumination.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE SEVERAL VIEWS OF THE DRAWING(S)

The technology described herein will be more fully understood by reference to the following drawings which are for illustrative purposes only:

FIG. 1A through FIG. 1J are method step comparisons between SIFT and DSP-SIFT according to an embodiment of the present disclosure.

FIG. 2A and FIG. 2B are bar charts of mean average precision (mAP) for different parameters utilized according to an embodiment of the present disclosure.

FIG. 3A through FIG. 3I are plots of average precision for different magnitudes of transformation using the Oxford dataset, comparing different descriptors including DSP-SIFT according to an embodiment of the present disclosure.

FIG. 4A through FIG. 4F are plots of average precision for different magnitudes of transformation using the Fischer dataset, comparing different descriptors including DSP-SIFT, according to an embodiment of the present disclosure.

FIG. 5A through FIG. 5J are plots of head-to-head descriptor comparison with DSP-SIFT utilized according to an embodiment of the present disclosure.

FIG. 6A and FIG. 6B are plots comparing SIFT-BOW and DSP-SIFT according to an embodiment of the present disclosure.

FIG. 7A and FIG. 7B are plots comparing SIFT-L and DSP-SIFT according to an embodiment of the present disclosure.

FIG. 8A and FIG. 8B are plots of complexity (descriptor dimension) and performance (mAP) tradeoff for RAW-PATCH, SIFT, SLS, CNN-L4-PS91, CNN-L3-PS91, CNN-L4-PS69, and CNN-L3-PS69, compared with an embodiment of DSP-SIFT according to the present disclosure.

FIG. 9A and FIG. 9B are diagrams of comparing scale-space versus size-space as utilized according to an embodiment of the present disclosure.

FIG. 10 is a plot of uncertainty principle linking the size of the domain of a filter (ordinate) to its spatial frequency (abscissa).

FIG. 11 is a plot of mean average precision across domain sizes.

FIG. 12A through FIG. 12I are plots of detector specificity in relation to descriptor sensitivity.

FIG. 13A through FIG. 13F are an image and graphs depicting aspects of aliasing.

FIG. 14 is a plot of unidirectionality of mapping over scale according to an embodiment of the present disclosure.

FIG. 15 is a plot of performance for varying choices of base size.

FIG. 16A through FIG. 16E are images depicting dataset, test samples, and qualitative match visualization as utilized according to an embodiment of the present disclosure.

FIG. 17A through FIG. 17F are plots of precision-recall curves for descriptors.

FIG. 18A and FIG. 18B are plots of distance distributions between descriptors of corresponding and non-corresponding patches for SV-HoG and MV-HoG.

FIG. 19A through FIG. 19D are plots of accuracy, excitation, spatial aggregation and time complexity.

### DETAILED DESCRIPTION

1. Introduction to DSP-SIFT.

Local image descriptors, such as SIFT and its variants, are designed to reduce variability due to illumination and vantage point while retaining discriminative power. This facilitates finding correspondence between different views of the same underlying scene. In a wide-baseline matching task on the Oxford benchmark, nearest-neighbor SIFT descriptors achieve a mean average precision (mAP) of 27.50%, a 71.85% improvement over direct comparison of normalized grayscale values. Other datasets yield similar results. Functions that reduce sensitivity to nuisance variability can also be learned from data. Convolutional neural networks (CNNs) can be trained to “learn away” nuisance variability while retaining class labels using large annotated datasets. In particular, one approach to descriptor matching with convolutional neural networks uses (patches of) natural images as surrogate classes and adds transformed versions to train the network to discount nuisance variability. The activation maps in response to image values can be interpreted as a descriptor and used for correspondence. Some researchers have demonstrated that CNN outperforms SIFT, albeit with a much larger dimension.

By contrast to these approaches, the present disclosure introduces a readily implemented modification of SIFT obtained by pooling gradient orientations across different domain sizes (“scales”), in addition to spatial locations, which improves SIFT by a considerable margin, so that it even outperforms the best known CNN approach. The resulting descriptor “domain-size pooled” SIFT is referred to herein as DSP-SIFT.

The ability to pool across different domain sizes can be readily coded in the descriptor instructions, and applied to any histogram-based method, and yields a descriptor of the same size that uniformly outperforms the original. Yet, combining histograms of images of different sizes seems counterintuitive and seemingly at odds with the teachings of scale-space theory and the resulting established practice of scale selection. The process, however, finds its roots in classical sampling theory and anti-aliasing.

1.1 Related Work.

A single, un-normalized cell of the “scale-invariant feature transform” SIFT and its variants can be written compactly as a formula:

h_{SIFT}(θ|I, \hat{σ})[x]=∫ [symbol] _{∈}(θ−∠∇I(y)) [symbol] _{\hat{σ}}(y−x)dμ(y) (1)

where I is the image restricted to a square domain, centered at a location x ∈ Λ (\hat{σ}) with size \hat{σ} in the lattice Λ determined by the response to a difference-of-Gaussian (DoG) operator across all locations and scales (SIFT detector). Here dμ(y)≐∥∇I(y)∥dy, θ is the independent variable, ranging from 0 to 2π, corresponding to an orientation histogram bin of size ∈, and σ̂ as the spatial pooling scale. The kernel [symbol] _{∈} is bilinear of size ∈ and [symbol] _{\hat{σ}} separable-bilinear of size σ̂, although they could be replaced by a Gaussian with standard deviation σ̂ and an angular Gaussian with dispersion parameter ∈. In at least one embodiment, the SIFT descriptor is the concatenation of 16 cells computed at locations x ∈{x₁, x₂, . . . , x₁₆} on a 4×4 lattice Λ, and normalized.

The spatial pooling scale σ̂ and the size of the image domain where the SIFT descriptor is computed Λ=Λ(σ̂) are tied to the photometric characteristics of the image, since σ̂ is derived from the response of a DoG operator on the (single) image. It should be noted that approaches based on “dense SIFT” forgo the detector and instead compute descriptors on a regular sampling of locations and scales. However, no existing dense SIFT method performs domain-size pooling. Such a response depends on the reflectance properties of the scene and optical characteristics and resolution of the sensor, neither of which is related to the size and shape of co-visible (corresponding) regions. Instead, how large a portion of a scene is visible in each corresponding image(s) depends on the shape of the scene, the pose of the two cameras, and the resulting visibility (occlusion) relations. Therefore, the disclosed method unties the size of the domain where the descriptor is computed (“scale”) from photometric characteristics of the image, departing from the teachings of scale selection. Instead, the disclosure diverts back to principles of classical sampling theory and anti-aliasing to achieve robustness to domain size changes due to occlusions.

Pooling is commonly understood as the combination of responses of feature detectors/descriptors at nearby locations, aimed at transforming the joint feature representation into a more usable one that preserves important information (intrinsic variability) while discarding irrelevant detail (nuisance variability). However, precisely how pooling trades off these two conflicting aims is unclear and mostly addressed empirically in end-to-end comparisons with numerous confounding factors. Exceptions include where intrinsic and nuisance variability are combined and abstracted into the variance and distance between the means of scalar random variables in a binary classification task. For more general settings, the goals of reducing nuisance variability while preserving intrinsic variability is elusive as a single image does not afford the ability to separate the two.

An alternate interpretation of pooling as anti-aliasing clearly highlights its effects on intrinsic and nuisance variability. It should be appreciated that because one cannot know what portion of an object or scene will be visible in a test image, a scale-space (“semi-orbit”) of domain sizes (“receptive fields”) should be marginalized or searched over (“max-out”). Neither can these be computed in closed-form, so the semi-orbit has to be sampled. To reduce complexity, only a small number of samples should be retained, resulting in undersampling and aliasing phenomena that can be mitigated by anti-aliasing, with quantifiable effects on the sensitivity to nuisance variability. For the case of histogram-based descriptors, anti-aliasing planar translations consist of spatial pooling, routinely performed by most descriptors. Anti-aliasing visibility results in domain-size aggregation, which no current descriptor practices. This interpretation also offers a way to quantify the effects of pooling on discriminative (reconstruction) power directly, using classical results from sampling theory, rather than indirectly through an end-to-end classification experiment that may contain other confounding factors.

Domain-size pooling can be applied to a number of different descriptors or convolutional architectures. Its effects on the most popular, SIFT are demonstrated in this disclosure. However, it should be pointed out that proper marginalization requires the availability of multiple images of the same scene, and therefore cannot be performed in a single image. While most local image descriptors are computed from a single image, there are exceptions. Of course, multiple images can be “hallucinated” from one image, but the resulting pooling operation can only achieve invariance to modeled transformations.

In neural network architectures, there is evidence that abstracting spatial pooling hierarchically, for instance aggregating nearby responses in feature maps, is beneficial. This process could be extended by aggregating across different neighborhood sizes in feature space. To the best of our knowledge, the only architecture that performs any kind of pooling across scales is an ad-hoc process. Other works learn the regions for spatial pooling but still restrict pooling to within-scale rather than across scales as in the present disclosure.

It should be appreciated that multi-scale methods that concatenate descriptors computed independently at each scale, should be distinguished from cross-scale pooling, where statistics of the image at different scales are combined directly in the descriptor. An example of the former is when ordinary SIFT descriptors computed on domains of different sizes are assumed to belong to a linear subspace, and where Fischer vectors are computed for multiple sizes and aspect ratios and spatial pooling occurs within each level. In addition, bag-of-word (BoW) methods, as mid-level representations, aggregate different low level descriptors by counting their frequency after discretization. Typically, vector quantization or other clustering techniques are utilized, in which each descriptor is associated with a cluster center (“word”), and the frequency of each word is recorded in lieu of the descriptors themselves. This can be accomplished for domain size, by computing different descriptors at the same location, for different domain sizes, and then counting frequencies relative to a dictionary learned from a large training dataset.

Aggregation across time, which may include changes of domain size, are advocated in the paper (P. Hamel, S. Lemieux, Y. Bengio, and D. Eck. Temporal pooling and multiscale learning for automatic annotation and ranking of music audio. In Proc. of the International Society of Music Information Retrieval, pages 729-734, 2011.) However, in the absence of formulas it is unclear how such an approach even relates to the present disclosure. One researcher shares weights across scales, which is clearly not equivalent to pooling, and is just indicative of some dependencies across scales. The MTD method (T. Lee and S. Soatto. Learning and matching multiscale template descriptors for real-time detection, localization and tracking. In Proc. of the Conference on Computer Vision and Pattern Recognition (CVPR), pages 1457-1464, IEEE, 2011.) appears to be the first instance of pooling across scales, although the aggregation is global in scale-space with consequent loss of discriminative power. Most recently, one paper (Y. Gong, L. Wang, R. Guo, and S. Lazebnik. Multi-scale orderless pooling of deep convolutional activation features. ArXiv preprint:1403.1840, 2014), advocates the same, but in practice space-pooled VLAD descriptors obtained at different scales are simply concatenated. There are also other approaches might be generally thought of as some form of pooling, but the resulting descriptor only captures the mean of the resulting distribution. In addition, one researcher exploits the possibility of estimating proper scales for nearby features via scale propagation, but again it still performs no pooling across scales.

2. Domain-Size Pooling.

If SIFT is written as in Eq. 1, then DSP-SIFT is given by

h_{DSP}(θ|I)[x]=∫h_{SIFT}(θ|I,σ)[x]εₛ(σ)dσ x ∈ Λ (2)

where s>0 is the size-pooling scale and ε is an exponential or other unilateral density function.

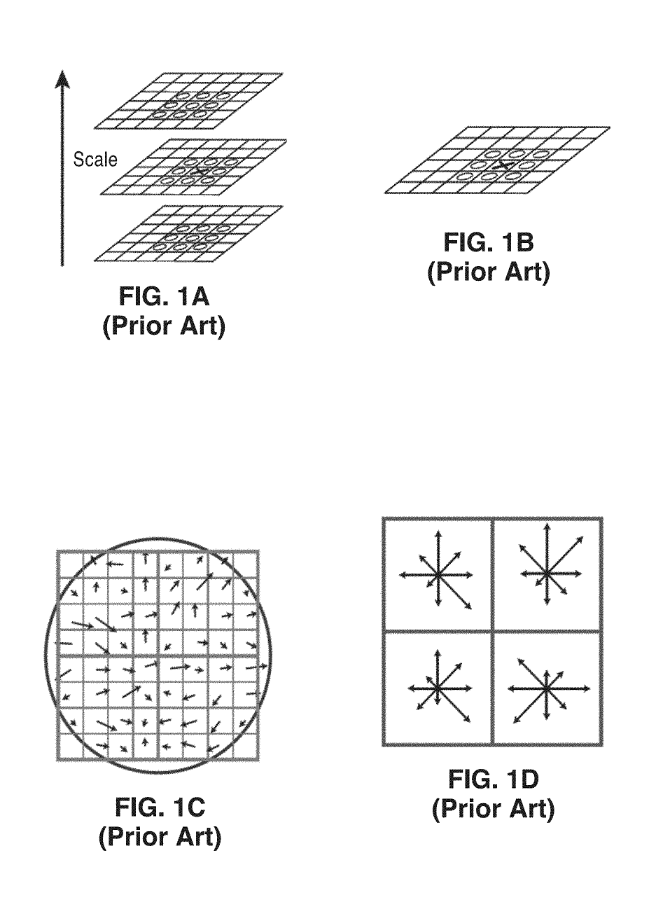

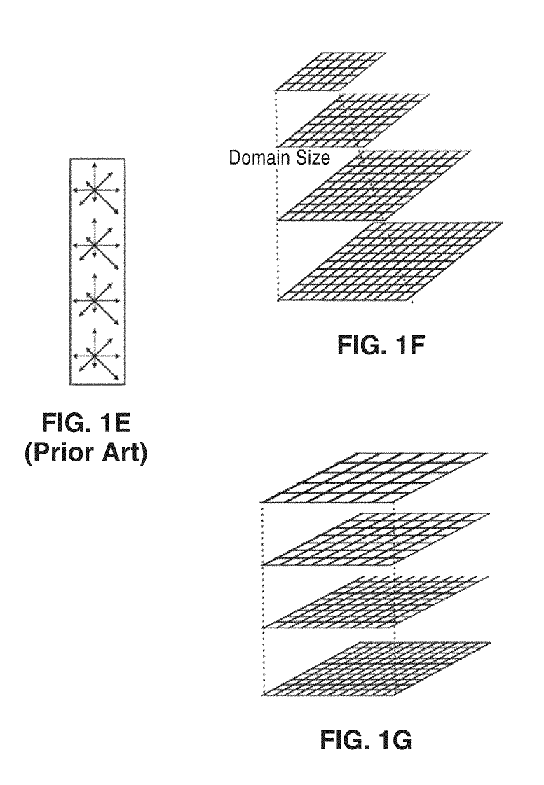

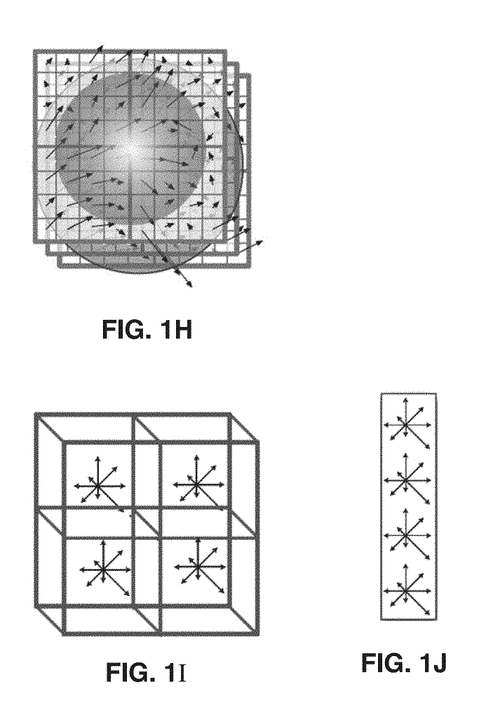

FIG. 1A through FIG. 1J illustrate a comparison between the SIFT and DSP-SIFT methods. It should be noted that generating descriptors for an image is generally performed using instructions (programming) executing on a system having at least one computer processor and memory. For the sake of simplicity of illustration, these are not shown in these figures.

In FIG. 1A through FIG. 1E SIFT steps are shown. SIFT is shown in FIG. 1A with isolated scales selected and the descriptor constructed from the image at the selected scale. In FIG. 1 B gradient orientations are determined. Then in FIG. 1C the gradient orientations are pooled in spatial neighborhoods. In FIG. 1D histograms are yielded that are concatenated and normalized to form the descriptor as seen in FIG. 1E.

In FIG. 1F through FIG. 1J the steps of DSP-SIFT are demonstrated in comparison to the SIFT. It should be appreciated that generating descriptors for image processing in SIFT is well known, wherein only the steps in FIG. 1F through FIG. 1J are shown which depart from that SIFT method. In FIG. 1F pooling occurs across different domain sizes. In FIG. 1G patches (portions of images) of different sizes are re-scaled, with gradient orientation determined as seen in FIG. 1H, which is pooled across locations and scales to generate histograms in FIG. 1I, which is concatenated yielding a descriptor seen in FIG. 1J, which is of the same dimensions as ordinary SIFT.

It should be appreciated that unlike SIFT, that is computed on a scale-selected lattice Λ(σ̂), DSP-SIFT is computed on a regularly sampled lattice Λ. Computed on a different lattice, the above can be considered to describe a DSP-HOG. Computed on a tree, it can be used to extend deformable-parts models (DPM) to DSP-DPM. Replacing hSIFT with other histogram-based descriptor “X” (for instance, the SURF method), the above yields DSP-X. Applied to a hidden layer of a convolutional network, it yields a DSP-CNN, or DSP-Deep-Fischer-Network.

While the implementation of DSP is straightforward, to implement the justification for it is less so. A summary and detailed derivation are described in later sections. Motivated by the experiments comparing local descriptors, SIFT was chosen as a paragon and compared with DSP-SIFT on a standard benchmark. Motivated by that, SIFT was compared to both supervised and unsupervised CNNs trained on ImageNet and Flickr respectively on the same benchmark, while DSP-SIFT was submitted to the same protocol. A test was also run on a new synthetic dataset that yields the same qualitative assessment.

Clearly, domain-size pooling of under-sampled semi-orbits cannot outperform fine sampling, so if a system were to retain all the scale samples instead of aggregating them, performance would further improve. However, computing and matching a large collection of SIFT descriptors across different scales would incur significantly increased computational and storage costs. To contain the latter, one researcher (V. Hassne, T. and Mayzels and L. Zelnik-Manor. On SIFTs and their scales. In Proc. of the Conference on Computer Vision and Pattern Recognition (CVPR), pages 1522-1528, IEEE, 2012.) assumes that descriptors at different scales populate a linear subspace and fit a high-dimensional hyperplane. The resulting scale-less SIFT (SLS) outperforms ordinary SIFT. However, the linear subspace assumption breaks when considering large scale changes, so SLS is outperformed by DSP-SIFT despite the considerable difference in (memory and time) complexity.

3. Implementation and Parameters.

Following other evaluation protocols, maximally stable extremal regions (MSER) are utilized to detect candidate regions, affine-normalize, re-scale and align them to the dominant orientation. For a detected scale σ̂, DSP-SIFT samples [symbol] σ̂ scales within a neighborhood (λ1σ̂, λ2σ̂) around it. For each scale-sampled patch, a single-scale un-normalized SIFT descriptor (updated version as described later) is determined on the SIFT scale-space octave corresponding to the sampled scale σ. By choosing εₛ to be a uniform density, these raw histograms of gradient orientations at different scales are accumulated and normalized. The SIFT practice is followed to normalize, clamp and re-normalize the histograms, with the clamping threshold set, such as by way of example to 0.067 empirically.

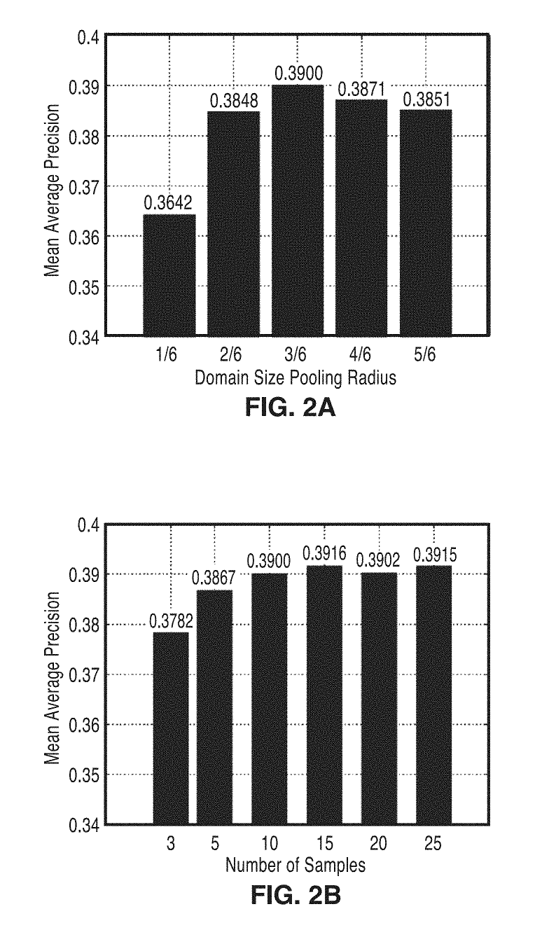

FIG. 2A and FIG. 2B depict mean average precision (mAP) for different parameters. In FIG. 2A it is seen that mAP changes with the radius s of DS pooling, with the best mAP achieved at ŝ=σ̂/2. In FIG. 2B mAP is shown as a function of the number of samples used within the best range (σ̂−ŝ, σ̂+ŝ). Thus, FIG. 2A illustrates mean average precision for different domain size pooling ranges. Improvements are observed as soon as more than one scale is utilized, with diminishing returns as each additional scale is added. Performance decreases with domain size pooling radius exceeding σ̂/2. While FIG. 2B indicates the effect of the number of size samples used to construct DSP-SIFT. Although generally speaking, more samples improve the results, three size samples are sufficient to outperform ordinary SIFT, and improvement beyond ten samples is minimal. Additional samples do not further increase the mean average precision, but incur more computational cost. In the evaluation in the next section, λ1=1/6, λ2=4/3 and Nσ̂=15, are utilized by way of example and not limitation. These parameters are empirically selected on the Oxford dataset.

4. Validation of the Approach.

As a baseline, the RAW-PATCH descriptor (named following P. Fischer, A. Dosovitskiy, and T. Brox. Descriptor matching with convolutional neural networks: a comparison to sift. ArXiv preprint: 1405.5769, 2014.) is the unit-norm grayscale intensity of the affine-rectified and resized patch of a fixed size (91×91).

The standard SIFT, which is widely accepted as a paragon, is computed using the VLFeat library. Both SIFT and DSP-SIFT are computed on the SIFT scale-space corresponding to the detected scales. Instead of mapping all patches to an arbitrarily user-defined size, the area of each selected and rectified MSER region is utilized to determine the octave level in the scale-space where SIFT (as well as DSP-SIFT) is to be computed.

Scale-less SIFT (SLS) is computed using the source code provided by the authors (V. Hassne, T. and Mayzels and L. Zelnik-Manor. On SIFTs and their scales. In Proc. of the Conference on Computer Vision and Pattern Recognition (CVPR), pages 1522-1528, IEEE, 2012) For each selected and rectified patch, the standard SIFT descriptors are computed at multiple scales (e.g., 20 scales in this example) from a desired scale range of (e.g., 0.5, 12), and the standard PCA subspace dimension is set to a desired value (e.g., 8), yielding a final descriptor of dimension (e.g., 8256) after a subspace-to-vector mapping.

A number of the validation elements are performed according to the “P. Fischer” article (P. Fischer, A. Dosovitskiy, and T. Brox. Descriptor matching with convolutional neural networks: a comparison to SIFT. ArXiv preprint:1405.5769, 2014.). To compare DSP-SIFT to a convolutional neural network, the top-performer from P Fischer was utilized in an unsupervised model pre-trained on 16000 natural images undergoing 150 transformations each (total 2.4M). The responses at the intermediate layers 3 (CNN-L3) and 4 (CNN-L4) are used for comparison, following the P. Fischer article. And since the network requires input patches of fixed size, results were tested and reported on both 69×69 (PS69) and 91×91 (PS91) as was performed in P. Fischer.

Although no direct comparison with multiscale template descriptors (MTD) is performed, SLS can be considered as dominating it since it uses all scales without collapsing them into a single histogram. The derivation in a later section suggests, and empirical evidence confirms that aggregating the histogram across all scales significantly reduces discriminative power. A later section compares DSP-SIFT to a BoW which pools SIFT descriptors computed at different sizes at the same location.

4.1. Image Datasets.

The Oxford dataset comprises 40 pairs of images of mostly planar scenes seen under different pose, distance, blurring, compression and lighting. They are organized into eight categories undergoing increasing magnitude of transformations. While routinely used to evaluate descriptors, this dataset has limitations in terms of size and restriction to mostly planar scenes, modest scale changes, and no occlusions. Fischer et al. in the paper mentioned above recently introduced a dataset of 400 pairs of images with more extreme transformations including zooming, blurring, lighting change, rotation, perspective and nonlinear transformations.

4.2. Metrics

Precision-recall (PR) curves were utilized as per the article (K. Mikolajczyk and C. Schmid. A performance evaluation of local descriptors. In IEEE Trans. on Pattern Analysis and Machine Intelligence., pages 1615-1630, 2005.) to evaluate descriptors. A match between two descriptors is called if their Euclidean distance is less than a threshold τ_{d}. In this embodiment, it is then labeled as a true positive if the area of intersection over union (IoU) of their corresponding MSER-detected regions is larger than 50%, alternate threshold levels can be selected as desired. Both datasets provide ground truth mapping between images, so the overlapping is computed by warping the first MSER region into the second image and then computing the overlap with the second MSER region. “Recall” is the fraction of true positives over the total number of correspondences. “Precision” is considered to be the percentage of true matches within the total number of matches. By varying the distance threshold τ_{d}, a PR curve can be generated and average precision (AP, a.k.a. area under the curve (AUC)) can be estimated. The average of APs provide the mean average precision (mAP) scores used for comparison.

4.3. Comparison of Descriptors.

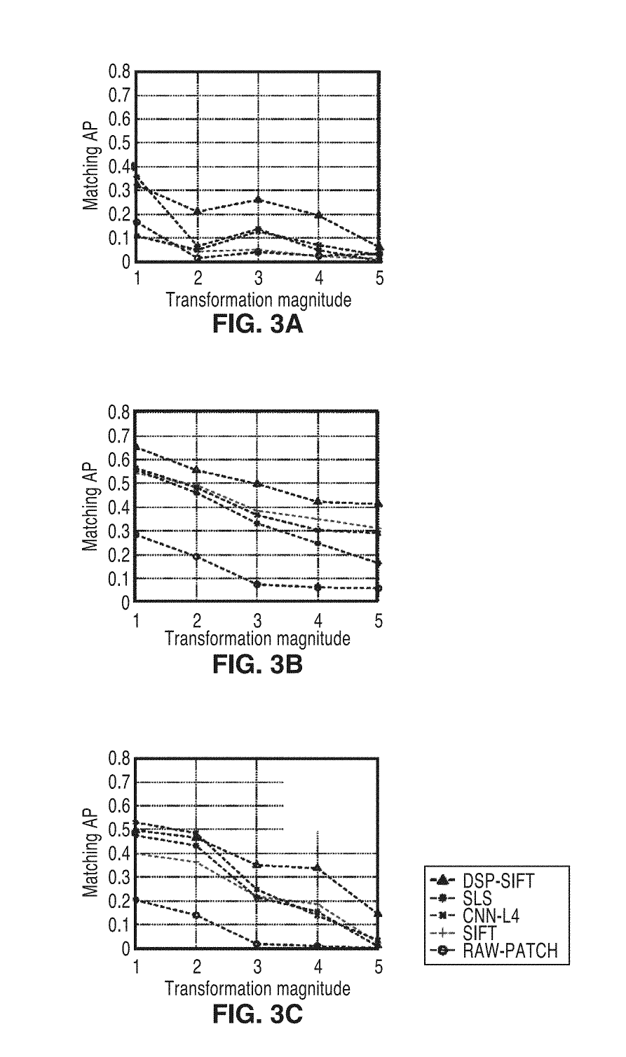

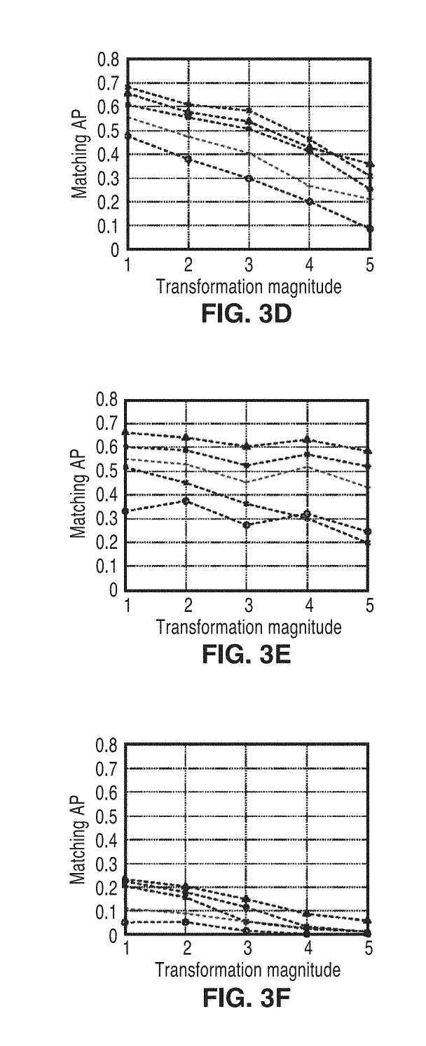

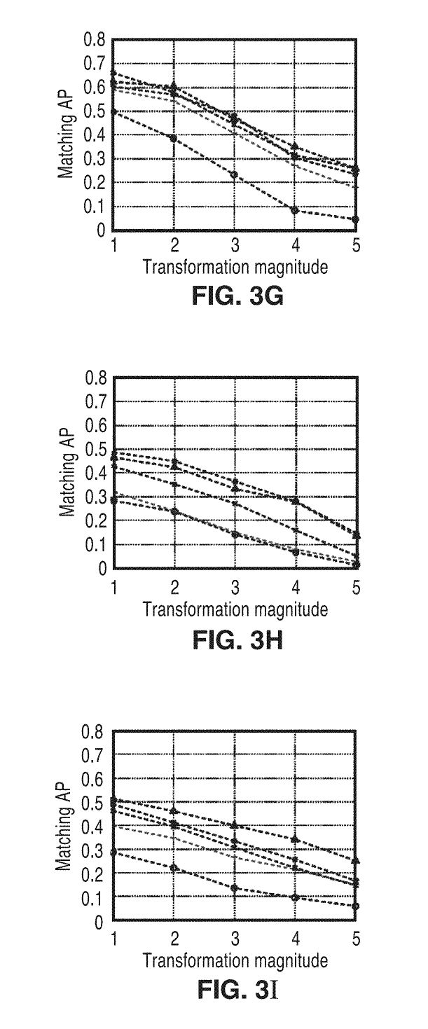

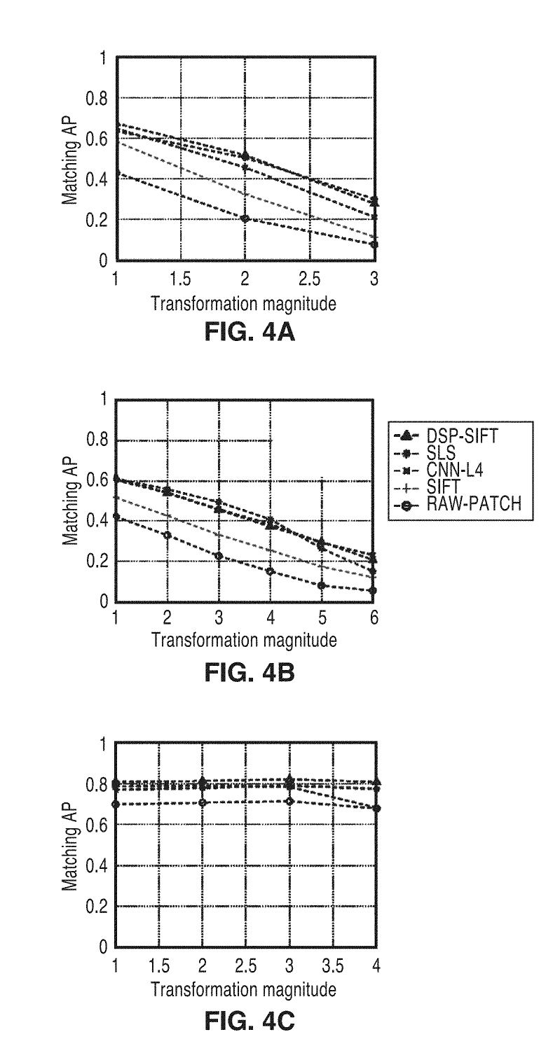

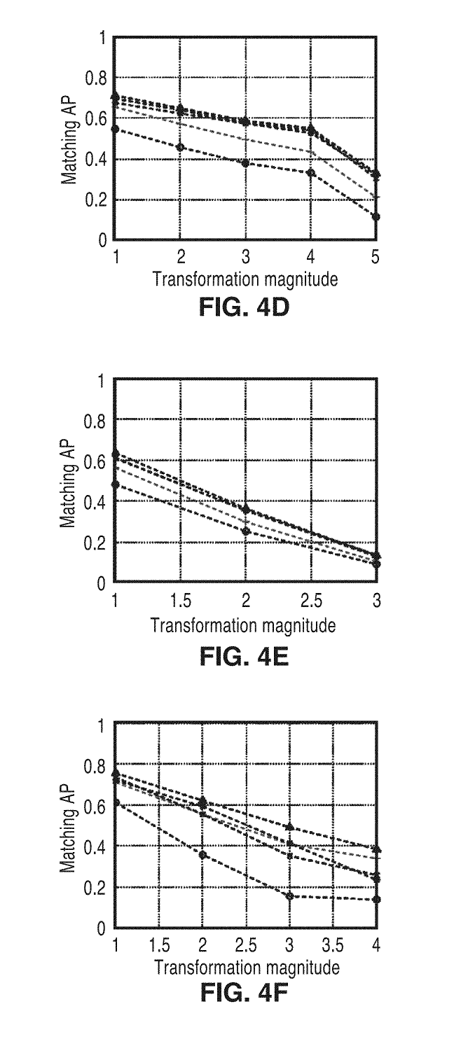

FIG. 3A through FIG. 3I and FIG. 4A through FIG. 4F depict the behavior of each descriptor for varying degrees of severity of each transformation. Each plot shows the value of a matching AP over a range of transformation magnitude for each of the descriptors DSP-SIFT, SLS, CNN-L4, SIFT, and RAW-PATCH.

In FIG. 3A through FIG. 3I the plots are directed to the Oxford dataset, and depict mAPs: zoom+rotation (bark) (FIG. 3A), blur (bikes)(FIG. 3B), zoom+rotation (boat) (FIG. 3C), viewpoint (grafitti) (FIG. 3D), lighting (leuven) (FIG. 3E), blur (trees) (FIG. 3F), compression (ubc) (FIG. 3G), viewpoint (wall) (FIG. 3H), and average over all images in Oxford (FIG. 3I).

In FIG. 4A through FIG. 4F the plots are directed to Fischer's dataset, and depict mAPs: nonlinear (FIG. 4A), zoom (FIG. 4B), lighting (boat) (FIG. 4C), perspective (FIG. 4D), rotation (FIG. 4E), blur (FIG. 4F).

As can be seen from the above plots, DSP-SIFT consistently outperforms other methods when there is a large scale change (zoom). It is also more robust to other transformations such as blur, lighting and compression in the Oxford dataset, and to nonlinear, perspective, lighting, blur and rotation in Fischer's dataset. DSP-SIFT is not at the top of the list of all compared descriptors in viewpoint change cases, although “viewpoint” is a misnomer as MSER-based rectification accounts for most of the viewpoint variability, and the residual variability is mostly due to interpolation and rectification artifacts. The fact that DSP-SIFT outperforms CNN in nearly all cases in Fischer's dataset is surprising, considering that the neural network is trained by augmenting the dataset using similar types of transformations.

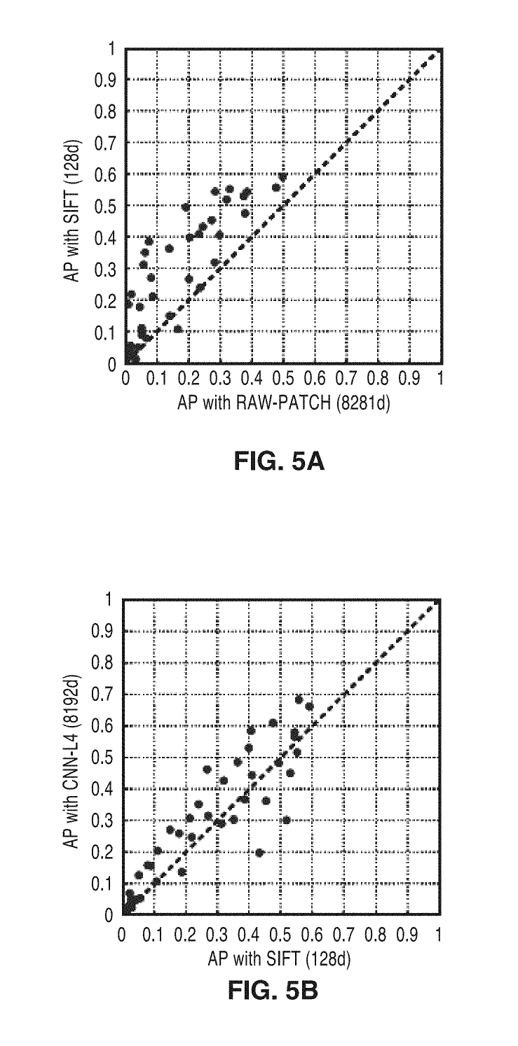

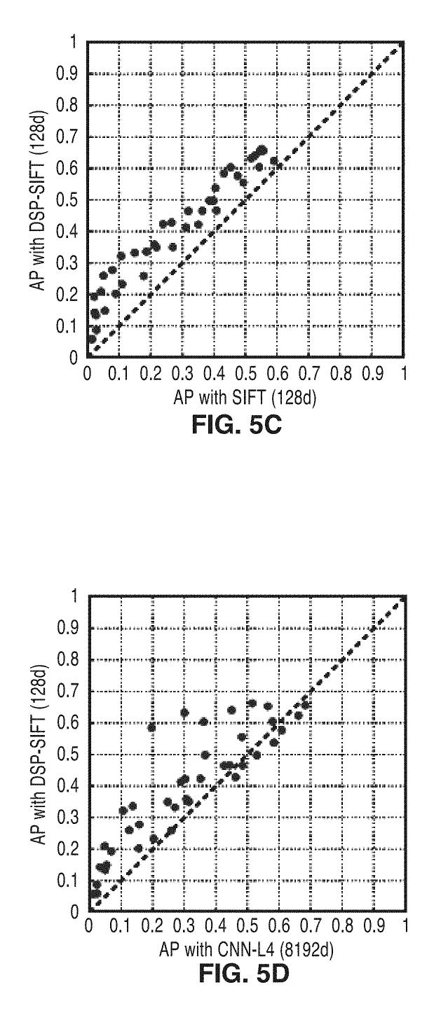

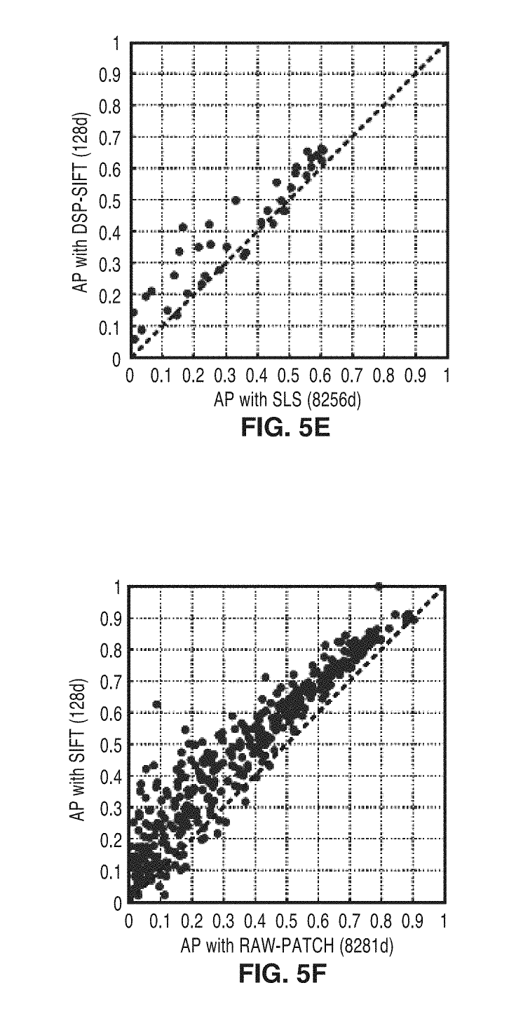

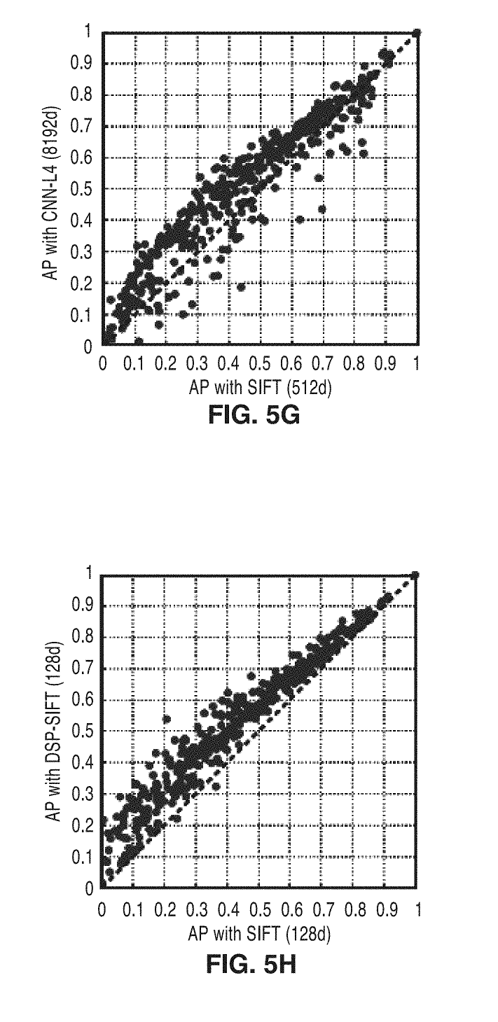

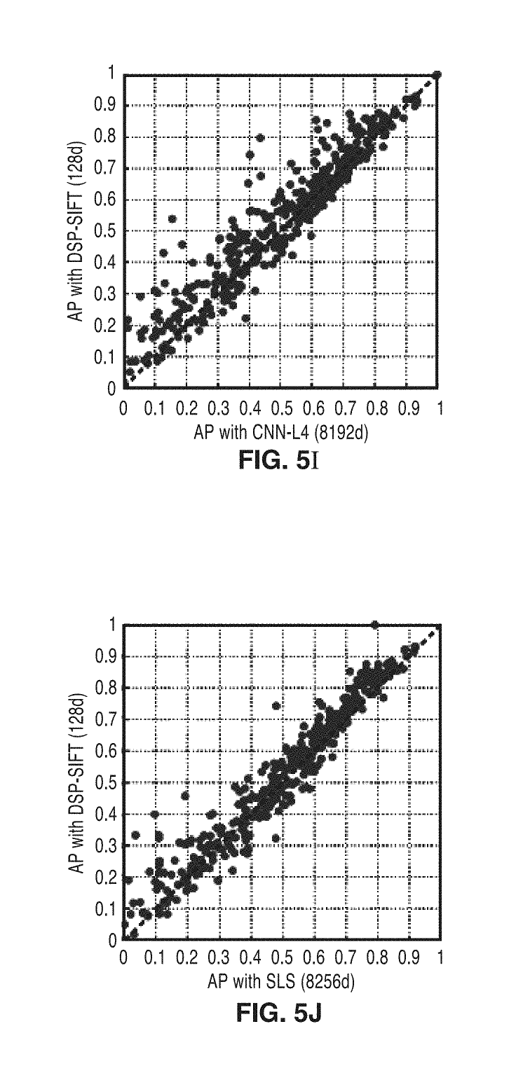

FIG. 5A through FIG. 5J depict head-to-head comparisons between these methods, with FIG. 5A through FIG. 5E using the Oxford dataset, and FIG. 5F through 5J utilizing the Fischer dataset. In these results it is seen that DSP-SIFT outperforms SIFT by 43.09% and 18.54% on Oxford and Fischer respectively. Only on two out of 400 pairs of images in Fischer dataset does domain-size pooling negatively affect the performance of SIFT, but the decrease is rather small. DSP-SIFT improves SIFT on every pair of images in the Oxford dataset. The improvement of DSP-SIFT comes without increase in dimension. In comparison, CNN-L4 achieves 11.54% and 11.53% improvements over SIFT by increasing dimension 64-fold. On both datasets, DSP-SIFT also consistently outperforms CNN-L4 and SLS despite its lower dimension.

4.4. Comparison with Bag-of-Words

To compare DSP-SIFT to BoW, SIFT was computed at 15 scales on concentric regions with dictionary sizes ranging from 512 to 2048, trained on over 100K SIFT descriptors computed on samples from ILSVRC-2013 (J. Deng, W. Dong, R. Socher, L.-J. Li, K. Li, and L. Fei-Fei. Imagenet: A large-scale hierarchical image database. In Proc. of the Conference on Computer Vision and Pattern Recognition (CVPR), pages 248-255, IEEE, 2009). To make the comparison fair, the same 15 scales are used to compute DSP-SIFT. By doing so, the only difference between these two methods is ‘how’ to pool across scales rather than ‘what or where’ to pool. In SIFT-BOW, pooling is performed by encoding SIFTs from nearby scales using the quantized visual dictionary, while DSP-SIFT combines the histograms of gradient orientations across scales directly. To compute similarity between SIFT-BOWs, both the intersection kernel and [symbol] ₁ norm were tested, and achieved a best performance with the latter at 20.62% mAP on Oxford and 39.63% on Fischer.

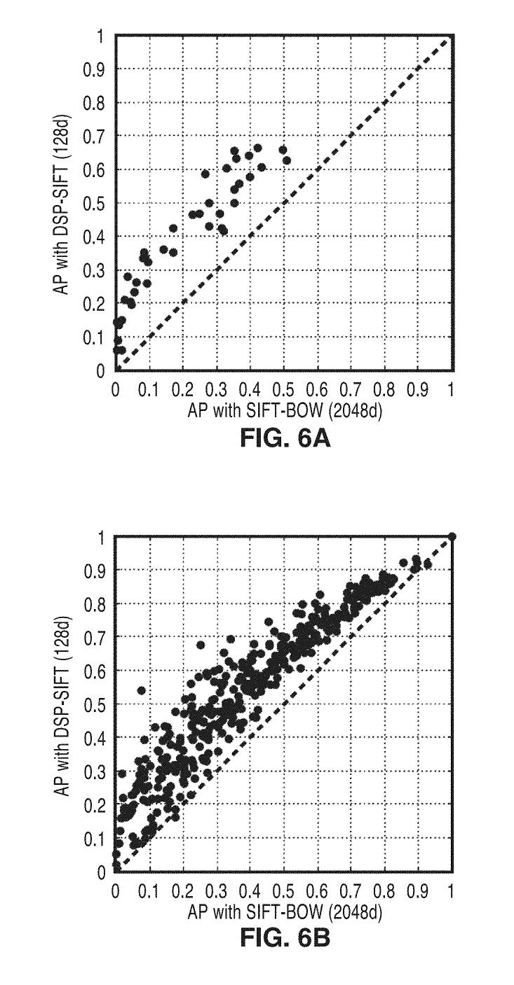

FIG. 6A and FIG. 6B depict a direct comparison between DSP-SIFT and SIFT-BOW with the former being a clear winner. Similarly to FIG. 5A through FIG. 5E, each point represents one pair of images in the Oxford (FIG. 6A) and Fischer (FIG. 6B) datasets. The coordinates indicate average precision for each of the two methods under comparison. The relative performance improvement of the winner is shown in the title of each panel. DSP-SIFT outperforms SIFT-BOW by 90.81% on the Oxford dataset, and by 35.57% on the Fischer dataset.

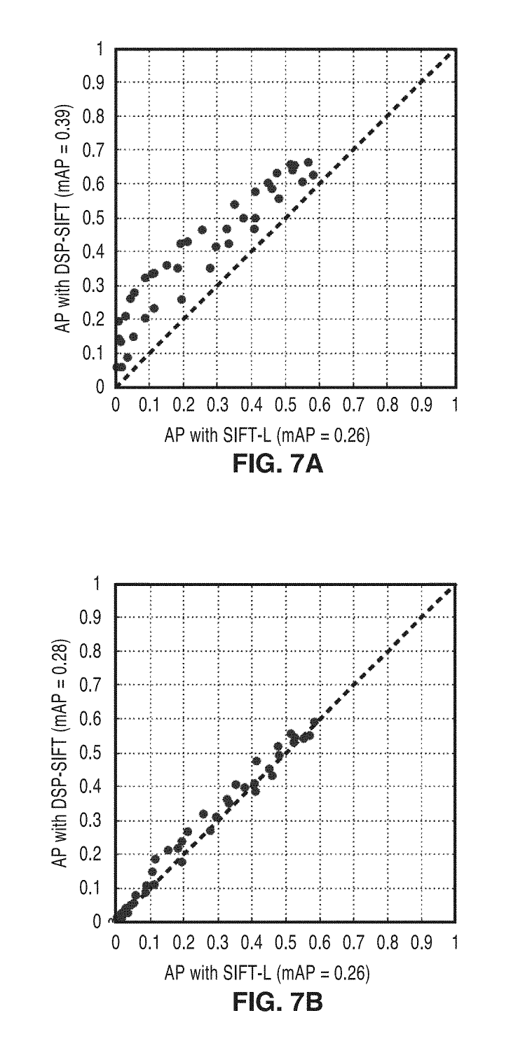

FIG. 7A and FIG. 7B depict a comparison between DSP-SIFT versus SIFT-L, again with each point representing one pair of images in the Oxford dataset. The coordinates indicate average precision for each of the two methods under comparison. The relative performance improvement of the winner is shown in the title of each panel, with DSP-SIFT providing 52.66% performance improvement over SIFT-L for a mAP of 0.39, and a 6.68% improvement for a mAP of 0.28. This shows that the improvement of DSP-SIFT comes from the pooling across domain sizes rather than choosing a larger domain size. It will be noted that FIG. 7B indicates that choosing a larger domain size actually decreases the performance of SIFT using the Oxford dataset.

4.5 Complexity and Performance Tradeoff.

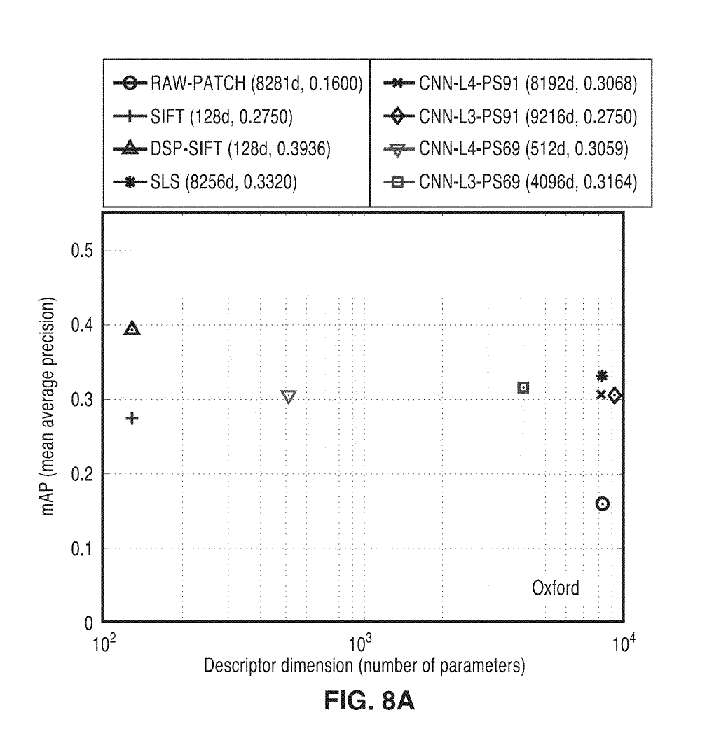

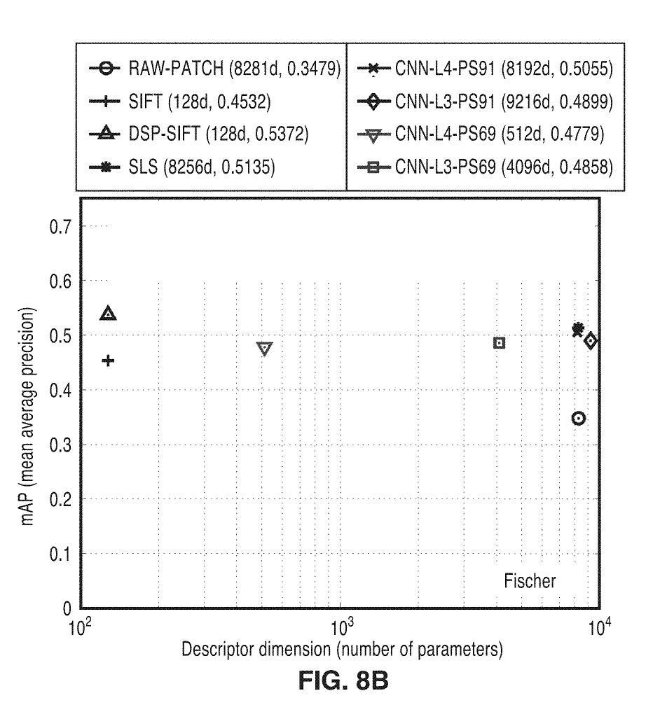

FIG. 8A and FIG. 8B shows the complexity (descriptor dimension) and performance (mAP) tradeoff for RAW-PATCH, SIFT, DSP-SIFT, SLS, CNN-L4-PS91, CNN-L3-PS91, CNN-L4-PS69, and CNN-L3-PS69. The abscissa is the descriptor dimension shown in log-scale, the ordinate shows the mean average precision. Table 1 summarizes the results.

In FIG. 8A and FIG. 8B, an “ideal” descriptor would achieve mAP=1 by using the smallest possible number of bits and land at the top-left corner of the graph. DSP-SIFT has the same lowest complexity as SIFT and is the best in mAP among all the descriptors. Looking horizontally in the graph, DSP-SIFT outperforms all the other methods at a fraction of their complexity. SLS achieves the second best performance but at the cost of a 64-fold increase in dimension. In general, the performance of CNN descriptors is worse than DSP-SIFT, but interestingly, their mAPs do not change significantly if the network responses are computed on a resampled patch of size 69×69 to obtain lower dimensional descriptors.

4.6 Comparison with SIFT on Larger Domain Sizes.

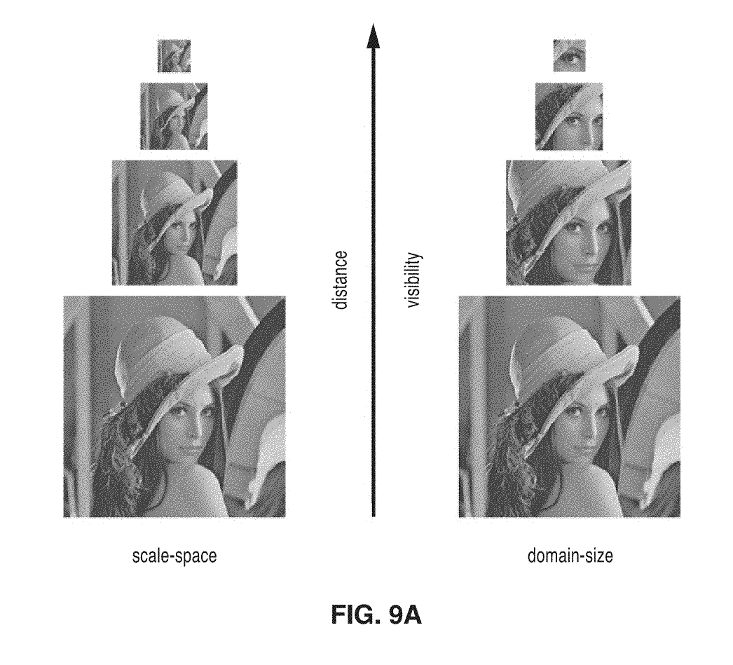

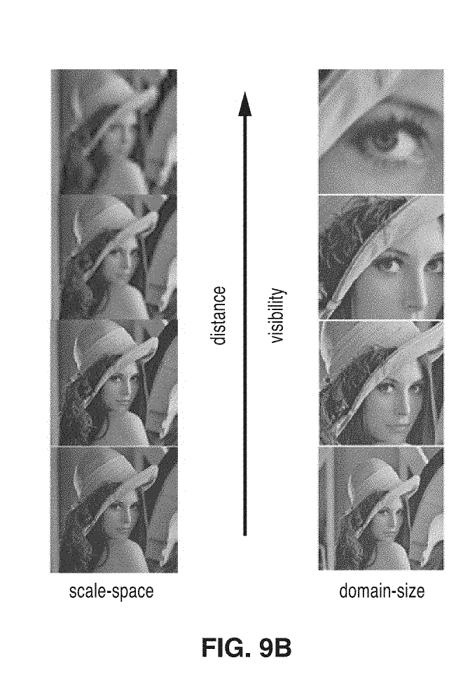

FIG. 9A and FIG. 9B illustrate scale-space versus size-space. Scale-space refers to a continuum of images obtained by smoothing and downsampling a base image. It is relevant to searching for correspondence when the distance to the scene changes. Size-space refers to a scale-space obtained by maintaining the same scale of the base image, but considering subsets of it of variable size. It is relevant to searching for correspondence in the presence of occlusions, so the size (and shape) of co-visible domains are not known.

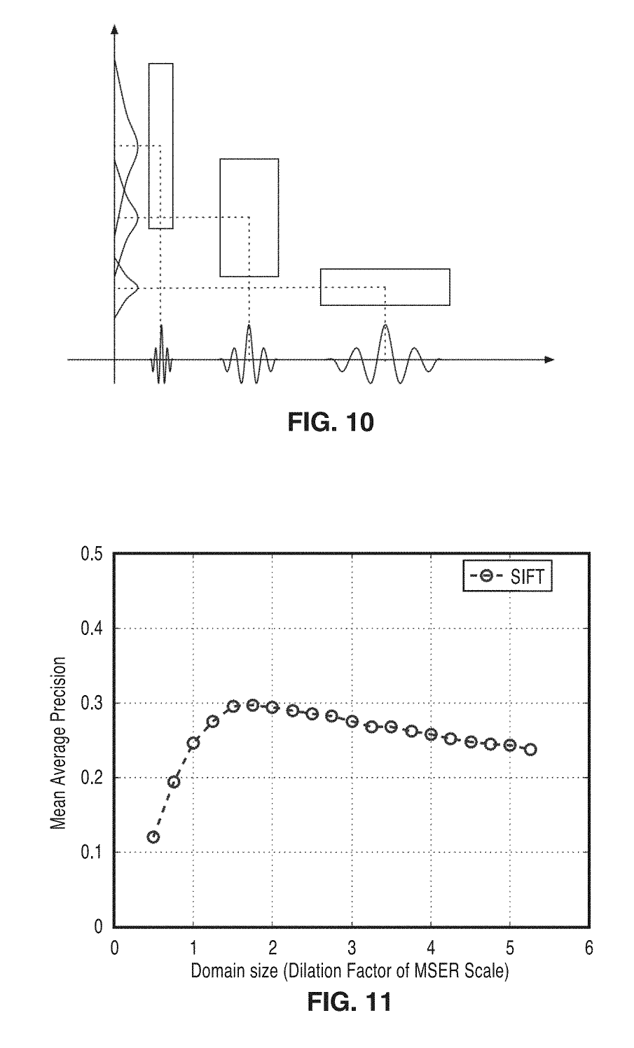

FIG. 10 illustrates the “uncertainty principle” linking the size of the domain of a filter (ordinate) to its spatial frequency (abscissa). As the data is analyzed for the purpose of compression, regions with high spatial frequency must be modeled at small scale, while regions with smaller spatial frequency can be encoded at large scale. When the task is correspondence, however, the size of the co-visible domain is independent of the spatial frequency of the scene within. While approaches using “dense SIFT” forgo the detector and compute descriptors at regularly sampled locations and scales, they perform spatial pooling by virtue of the descriptor, but fail to perform pooling across scales, as taught by the present disclosure.

FIG. 11 illustrates that descriptors computed on larger domain sizes are usually more discriminative, up to the point where the domain straddles occluding boundaries. In other words, the discriminative power of a descriptor (e.g., mAP of SIFT) increases with the size of the domain, but so does the probability of straddling an occlusion and the approximation error of the imaging model implicit in the detector/descriptor. This effect, which also depends on the base size, is most pronounced when occlusions are present, but is present even on the Oxford dataset, shown above.

When using a detector, the size of the domain is usually chosen to be a factor of the detected scale, which affects performance in a way that depends on the dataset and the incidence of occlusions. In our testing, this parameter (dilation factor) is set at 3 following convention, and not by way of limitation, and we note that DSP-SIFT is less sensitive than ordinary SIFT to this parameter. Since DSP-SIFT aggregates domains of various sizes (smaller and larger) around the nominal size, it is important to ascertain whether the improvement in DSP-SIFT comes from size pooling, or simply from including larger domains. To this end, DSP-SIFT is compared by pooling domain sizes from ⅙th through 4/3rd of the scale determined by the detector, to a single-size descriptor computed at the largest size (SIFT-L). This establishes that the increase in performance of DSP-SIFT over ordinary SIFT comes from pooling across domain sizes, not just by picking larger domain sizes. In the example in FIG. 7A the largest domain size yields an even worse performance than the detection scale in FIG. 7B. In a more complex scene where the test images exhibit occlusion, this will be even more pronounced as there is a tradeoff between discriminative power (calling for a larger size) and the probability of straddling an occlusion (calling for a smaller size).

5. Derivation of DSP-SIFT.

In this section we describe the trace of the derivation of DSP-SIFT, which is reported in a later section. Crucial to the derivation is the interpretation of a descriptor as a likelihood function.

A. The likelihood function of the scene given images is a minimal sufficient statistic of the latter for the purpose of answering questions on the former. Invariance to nuisance transformations induced by (semi-) group actions on the data can be achieved by representing orbits, which are maximal invariants. The planar translation-scale group can be used as a crude first-order approximation of the action of the translation group in space (viewpoint changes) including scale change-inducing translations along the optical axis. This draconian (very strict) assumption is implicit in most single-view descriptors.

B. Comparing (semi-) orbits entails a continuous search (non-convex optimization) that has to be discretized for implementation purposes. The orbits can be sampled adaptively, through the use of a co-variant detector and the associated invariant descriptor, or regularly—as is customary in classical sampling theory.

C. In adaptive sampling, the detector should exhibit high sensitivity to nuisance transformations (e.g., small changes in scale should cause a large change in the response to the detector, thus providing accurate scale localization) and the descriptor should exhibit small sensitivity (so small errors in scale localization cause a small change in the descriptor). Unfortunately, for the case of SIFT (DoG detector and gradient orientation histogram descriptor), the converse is true.

D. Because correspondence entails search over samples of each orbit, time complexity increases with the number of samples. Undersampling introduces structural artifacts, or “aliases,” corresponding to topological changes in the response of the detector. These can be reduced by “anti-aliasing,” an averaging operation. For the case of (approximations of) the likelihood function, such as SIFT and its variants, anti-aliasing corresponds to pooling. Spatial pooling is common practice, and reduces sensitivity to translation parallel to the image plane. Yet, however, scale pooling, which provides insensitivity to translation orthogonal to the image plane, and domain-size pooling, which provides insensitivity to small changes of visibility, are not. This motivates the introduction of DSP-SIFT, and the rich theory on sampling and anti-aliasing could provide guidelines on what and how to pool, as well as bounds on the loss of discriminative power resulting from undersampling and anti-aliasing operations.

6. Discussion.

Image matching under changes of viewpoint, illumination and partial occlusions is framed as a hypothesis testing problem, which results in a non-convex optimization over continuous nuisance parameters. The need for efficient test-time performance has spawned an industry of engineered descriptors, which are computed locally so the effects of occlusions can be reduced to a binary classification (co-visible, or not). The best known is SIFT, which has been shown to work well in a number of independent empirical assessments, that however comes with little analysis on why it works, or indications on how to improve it. The present disclosure is a significant movement in that direction, by showing that SIFT can be derived from sampling considerations, where spatial binning and pooling are the result of anti-aliasing operations. However, SIFT and its variants only perform such operations for planar translations, whereas our interpretation calls for anti-aliasing domain-size as well. Doing so can be accomplished readily by modifying the programming (e.g., a few additional lines of code) while it yields significant performance improvements. Such improvements even place the resulting DSP-SIFT descriptor above a convolutional neural network (CNN), that had been recently reported as a top performer in the Oxford image matching benchmark. Of course, replacing large neural networks with local descriptors is not advocated; as indeed there are interesting relations between DSP-SIFT and convolutional architectures.

Domain-size pooling, and regular sampling of scale “unhinged” from the spatial frequencies of the signal is divorced from scale selection principles, rooted in scale-space theory, wavelets and harmonic analysis. There, the goal is to reconstruct a signal, with the focus on photometric nuisances (additive noise). In the present disclosure, the size of the domain where images correspond depends on the three-dimensional shape of the underlying scene, and visibility (occlusion) relations, and has little to do with the spatial frequencies or “appearance” of the scene. Thus, the disclosed method does away with the linking of domain size and spatial frequency (“uncertainty principle”, FIG. 10).

DSP can be easily extended to other descriptors, such as HOG, SURF, CHOG, including those supported on structured domains such as DPMs, and to network architectures such as convolutional neural networks and scattering networks, opening the door to multiple extensions of the present work. In addition, a number of interesting open theoretical questions can now be addressed using the tools of classical sampling theory, given the novel interpretation of SIFT and its variants introduced in this paper.

7. Methodology Appendices

7A. Relation to Sampling Theory.

This first section summarizes the background needed for the derivation, reported in the next section.

7.A.1. Sampling and Aliasing.

In this section we refer to a general scalar signal f: [symbol] → [symbol] ; x [symbol] f(x), for instance the projection of the albedo of the scene onto a scanline. We define a detector to be a mechanism to select samples xᵢ, and a descriptor φᵢ to be a statistic computed from the signal of interest and associated with the sample i. In the simplest case, x is regularly sampled, so the detector does not depend on the signal, and the descriptor is simply the value of the function at the sample φᵢ=f (xᵢ). Other examples include:

7.A.1.1. Regular Sampling (Shannon '49).

The detector is trivial: {xᵢ}=Λ is a lattice, independent of f. The descriptor is a weighted average of fin a neighborhood of fixed size σ (possibly unbounded) around xᵢ:φᵢ=φ({f(x),x ∈ [symbol] _{σ}(xᵢ)}). Neither the detector nor the descriptor function φ depend on f (although the value of the latter, of course, does).

If the signal was band-limited, Shannon's sampling theory would offer guarantees on the exact reconstruction \hat{f} of f (x), x ∈ R from its sampled representation {xᵢ, φᵢ}}. Unfortunately, the signals of interest are not band-limited (images are discontinuous), and therefore the reconstruction \hat{f} can only approximate f. Typically, the approximation include “alien structures,” such as spurious extrema and discontinuities in \hat{f} that do not exist in f. This phenomenon is known as “aliasing”. To reduce its effects, one can replace the original data f with another f′~ that is (closer to) band-limited and yet close to f, so that the samples can encode \hat{f}=\tilde{f} free of aliasing artifacts. The conflicting requirements of faithful approximation of f and restriction on bandwidth trade-off discriminative power (reconstruction error) with complexity, which is one of the goals of communications engineering. This tradeoff can be optimized by a choice of anti-aliasing operator, that is the function that produces \tilde{f} from f, usually via convolution with a low-pass filter. In our context, we seek for a tradeoff between discriminative power and sensitivity to nuisance factors. This will come naturally when anti-aliasing is performed with respect to the action of nuisance transformations.

7.A.1.2. Adaptive Sampling (Landau '67).

The detector could be “adapted” to f by designing a functional ψ that selects samples {xi}=ψ(f). Typically, spatial frequencies of f modulate the length of the interval δxᵢ=xᵢ₊₁−xᵢ. A special case of adaptive sampling that does not requires stationarity assumptions is described next. The descriptor may also depend on ψ e.g., by making the statistic depend on a neighborhood of variable size σᵢ:=φᵢ({f(x),x ∈ [symbol] (xᵢ}).

7.A.1.3. Tailored Sampling (Logan '77).

For signals that are neither stationary nor band-limited, we can leverage on the violations of these assumptions to design a detector. For instance, if f contains discontinuities, the detector can place samples at discontinuous locations (“corners”). For band-limited signals, the detector can place samples at critical points (maxima, or “blobs”, minima, saddles). A (location-scale) co-variant detector is a functional ψ whose zero-level sets

ψ(f;s,t)=0 (3)

define isolated (but typically multiple) samples of scales sᵢ i >0 and locations tᵢ ∈ R locally as a function of f via the implicit function theorem, in such a way that if f is transformed, for instance via a linear operator depending on location τ and scale σ parameters, W(σ,τ)f, then so are the samples: ψ(W(σ,τ)f; s+σ, t+τ)=0.

The associated descriptor can then be any function of the image in the reference frame defined by the samples tᵢ, sᵢ , the most trivial being the restriction of the original function f to the neighborhood [symbol] ₛ_{ᵢ}(tᵢ). This, however, does not reduce the dimensionality of the representation. Other descriptors can compute statistics of the signal in the neighborhood, or on the entire line. Note that descriptors φᵢ could have different dimensions for each i .

7.A.1.4. Anti-aliasing and “Pooling”.

In classical sampling theory, anti-aliasing refers to low-pass filtering or smoothing that typically does not cause genetic phenomena (spurious extrema, or aliases, appearing in the reconstruction of the smoothed signal.) It will be noted that this central tenet of scale-space theory only holds for scalar signals. Nevertheless, genetic effects have been shown to be rare in two-dimensional Gaussian scale-space. Of course, anti-aliasing typically has destructive effects, in the sense of eliminating extrema that are instead present in the original signal.

A side-effect of anti-aliasing, which has implications when the goal is not to reconstruct, but to detect or localize a signal, is to reduce the sensitivity of the relevant variable (descriptor) to variations of the samples (detector). If we sample translations, xᵢ=x +tᵢ, and just store fᵢ=f(xᵢ), an arbitrarily small translation of the sample dx can cause an arbitrarily large variation in the representation δf(xᵢ)=f (xᵢ +dₓ)−fᵢ , when xᵢ is a discontinuity. So, the sensitivity

$$S ( f ) = \frac{δ f}{dx} = ∞ .$$

An anti-aliasing operator ψ(f) should reduce sensitivity to translation:

$$\frac{δ φ ( f )}{dx} << \frac{δ f}{dx} .$$

Of course, this could be trivially achieved by choosing ψ(f)=0 for any f. The goal is to trade off sensitivity with discriminative power. For the case of translation, this tradeoff has been described, however, similar considerations hold for scale and domain-size sampling.

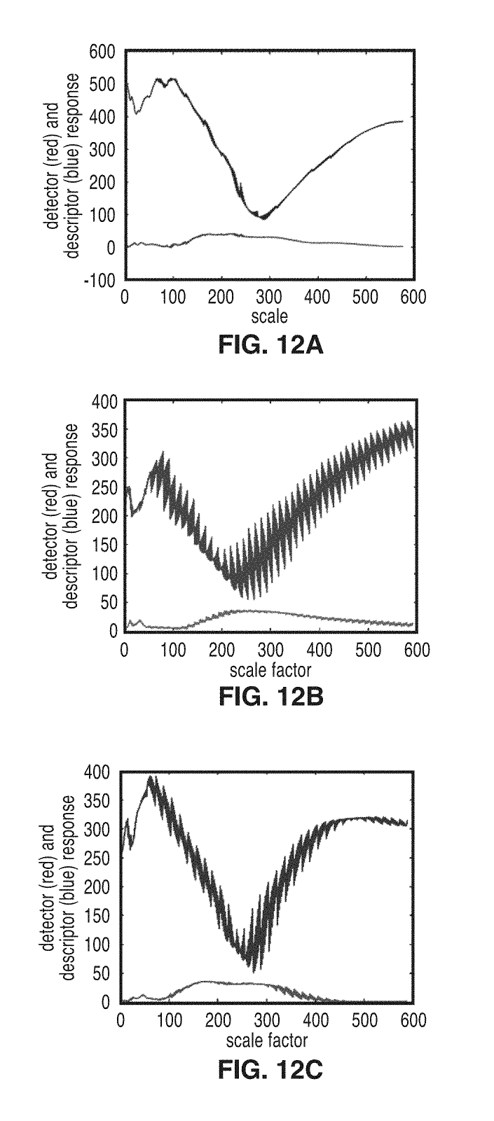

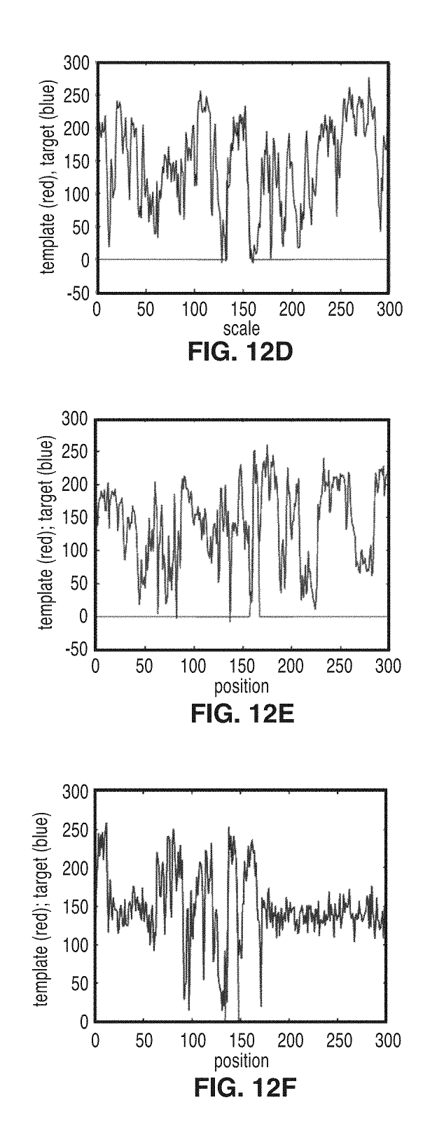

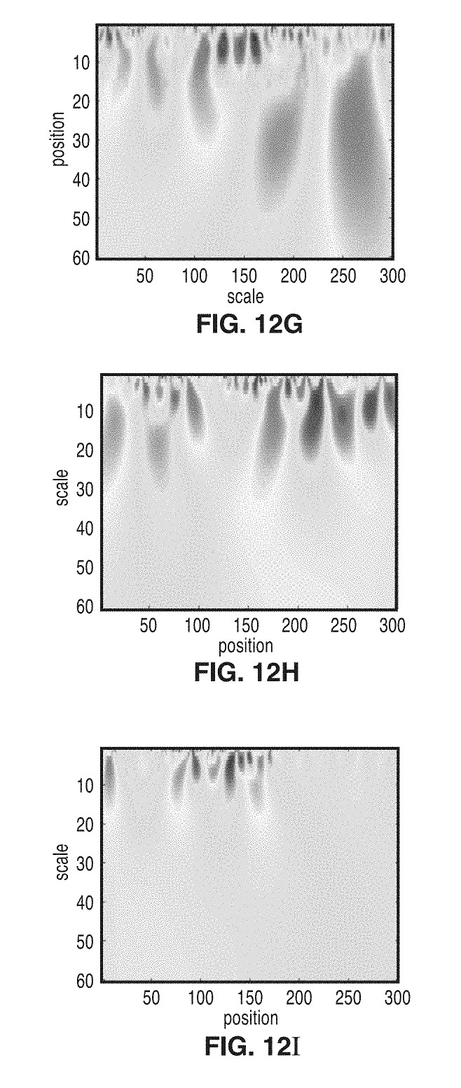

FIG. 12A through FIG. 12I depict detector specificity versus descriptor sensitivity. In FIG. 12A through FIG. 12C changes in detector response (lower curve) are seen as a function of scale, computed around the optimal location and scale (here corresponding to a value of 245), and corresponding change of descriptor value (upper curve). An ideal detector would have high specificity (sharp maximum around the true scale) and an ideal descriptor would have low sensitivity (broad minimum around the same). However, the opposite is true, which means that it is difficult to precisely select scale, and selection error results in large changes in the descriptor. Experiments are for the DoG detector and identity descriptor. In FIG. 12D through FIG. 12F template p versus target f curves are shown, it will be seen that the template curve is at 0 then peaks toward matching the curve. It should be noted that these curves, as with many others herein, were created in colors, however they are shown here in monochrome due to the limitation of image submissions in the patent application process. In FIG. 12G through FIG. 12I is scale-space [f] is depicted. It should be noted that the maximum detector response may not even correspond to the true location. The jaggedness of the response is an aliasing artifact.

7.B. Derivation of DSP-SIFT.

The derivation of DSP-SIFT and its extensions follows a series of steps summarized as follows:

We start from the correspondence, or matching, task: Classify a given datum f (test image, or target) as coming from one of M model classes, each represented by an image ρj (training images, or templates), with j=1, . . . , M.

Both training and testing data are affected by nuisance variability due to changes of: (i) illumination, (ii) vantage point, and (iii) partial occlusion. The former is approximated by local contrast transformations (monotonic continuous changes of intensity values), a maximal invariant to which is the gradient orientation. Vantage point changes are decomposed as a translation parallel to the image plane, approximated by a planar translation of the image, and a translation orthogonal to it, approximated by a scaling of the image. Partial occlusions determine the shape of corresponding regions in training and test images, which are approximated by a given shape (for example a circle, or square) of unknown size (scale). These are very crude approximations but nevertheless implicit to most local descriptors. In particular, camera rotations are not addressed in this work, although others have done so.

Solving the (local) correspondence problem amounts to an M+1-hypothesis testing problem, including the background class. Nuisance (i) is eliminated at the outset by considering gradient orientation instead of image intensity. Dealing with nuisances (ii)-(iii) requires searching across all (continuous) translations, scales, and domain sizes.

The resulting matching function must be discretized for implementation purposes. Since the matching cost is quadratic in the number of samples, sampling should be reduced to a minimum, which in general introduces artifacts (“aliasing”).

Anti-aliasing operators can be used to reduce the effects of aliasing artifacts. For the case of (approximations of) the likelihood function, such as SIFT, anti-aliasing corresponds to marginalizing residual nuisance transformations, which in turn corresponds to pooling gradient orientations across different locations, scales and domain sizes.

The samples can be thought of as a special case of “deformation hypercolumns” (samples with respect to the orientation group) with the addition of the size-space semi-group (seen in FIG. 9B). Most importantly, the samples along the group are anti-aliased, to reduce the effects of structural perturbations.

7.B.1. Formalization.

For simplicity, the matching problem is formalized for a scalar image (a scanline), and contrast changes are neglected for now, focusing on the location-scale group and domain size instead.

Let ρj : R→R, with j=1, . . . , M possible models (templates, or ideal training images). The data (test image) is f:[0, . . . , N ]→R with each sample f(xᵢ) obtained from one of the ρj via translation by τ ∈ R, scaling by σ>0, and sampling with interval ∈, if xᵢ is in the visible domain [a, b]. Otherwise, the scene ρj is occluded and f(xᵢ) has nothing to do with it. The forward model that, given ρ and all nuisance factors σ,τ,a, b, generates the data, is indicated as follows: If xᵢ ∈ [a, b] then

f(xᵢ)=W_{ε}(xᵢ;σ,τ)ρⱼ+nᵢⱼ (4)

where nᵢ is a sample of a white, zero-mean Gaussian random variable with variance κ. Otherwise, xᵢ ∉[a, b], and f(xᵢ)=β(xᵢ) is a realization of a process independent of ρj (the “background”). The operator W_{ε} is linear and given by

$${W}_{ε} ( {x}_{i} ; σ , τ ) p ≐ {\int }_{{ℬ}_{ε} ( {x}_{i} )} ρ ( \frac{x - τ}{σ} ) dx \qquad ( 6 )$$

where [symbol] _{ε}(xᵢ) is a region corresponding to a pixel centered at xᵢ.

It should be noted that W: [symbol] ²( [symbol] )→ [symbol] ^{N} can be written as an integral on the real line using the characteristic function [symbol] (x−xᵢ) or a more general sampling kernel κ_{∈}(x−xᵢ) for instance a Gaussian with zero-mean and standard deviation ∈. Then we have

$${\int }_{{ℬ}_{ε} ( {x}_{i} )} ρ ( \frac{x - τ}{σ} ) dx = \int {k}_{ε} ( x - {x}_{i} ) ρ ( \frac{x - τ}{σ} ) dx = \int \int δ ( y - \frac{x - τ}{σ} ) {k}_{ε} ( x - {x}_{i} ) ρ ( y ) dxdy = \int \int δ ( y + \frac{τ}{σ} - \frac{x}{σ} ) {k}_{ε} ( x - {x}_{i} ) dx ρ ( y ) dy = \int \int δ ( y + \frac{τ}{σ} - \overline{x} ) {k}_{ε} ( σ \overline{x} - {x}_{i} ) σ d \overline{x} ρ ( y ) dy = σ \int {k}_{ε} ( σ y + τ - {x}_{i} ) ρ ( y ) dy \qquad ( 5 )$$

Matching then amounts to a hypothesis testing problem on whether a given measure f={f(xᵢ)}ᵢ₌₁^{N} is generated by any of the ρj, under suitable choice of nuisance parameters, or otherwise is just labeled as background:

H₀:∃j, a, b, σ, τ|ρ(f(xᵢ)|Pj, a, b, σ, τ)=P_{β}({f(x_{κ}), x_{κ}∉[a, b]})Πxᵢ∈[a, b] [symbol] (f(xᵢ)−W_{∈}(xᵢ; σ, τ)ρⱼ), κ) (7)

and the alternate hypothesis is simply p_{β}({f(xᵢ)}ᵢ₌₁^{N}). If the background density ρβ is unknown, the likelihood ratio test reduces to the comparison of the product on the right-hand side to a threshold, typically tuned to the ratio with the second-best match (although some recent work using extreme-value theory improves this). In any case, the log-likelihood for points in the interval xᵢ ∈ [a, b] can be written as:

$${r}_{ij} ( a , b , σ , τ ) = \frac{1}{\vert b - a \vert} {\sum }_{{x}_{i} ε [ a , b ]} \vert f ( {x}_{i} ) - {W}_{ε} ( {x}_{i} ; σ , τ ) {ρ}_{j} \vert \qquad ( 8 )$$

which will have to be minimized for all pixels i=1, . . . , N and templates j=1, . . . , M, of which there is a finite number. However, it also has to be minimized over the continuous variables σ, τ, a, b. Since r is in general neither convex nor smooth as a function of these parameters, analytical solutions are not possible. Discretizing these variables is necessary, and since the minimization amounts to a search in 2+4 dimensions, we seek for methods to reduce the number of samples with respect to the arguments σ, τ, a, b, as much as possible. It should be noted that coarse-to-fine, homotopy-based methods or jump-diffusion processes can alleviate, but not remove, this burden.

There are many ways to perform sampling, some previously described, so several questions are in order: (a) How should each variable be sampled? Regularly or adaptively? (b) If sampled regularly, when do aliasing phenomena occur? Can anti-aliasing be performed to reduce their effects? (c) The search is jointly over a, b and σ,τ and given one pair, it is easy to optimize over the other. Can these two be “separated”? (d) Is it possible to quantify and optimize the tradeoff between the number of samples and classification performance? Or for a given number of samples develop the “best” anti-aliasing (“descriptor)? (e) For a histogram descriptor, how is “anti-aliasing” accomplished?

7.B.2. Common Approaches and their Rationale.

Concerning question (a) above, most approaches in the literature perform tailored sampling of both τ and σ, by deploying a location-scale covariant detector. When time is not a factor, it is common to forgo the detector and compute descriptors “densely” (a misnomer) by regularly subsampling the image lattice, or possibly undersampling by a fixed “stride.” Sometimes, scale is also regularly sampled, typically at far coarser granularity than the scale-space used for scale selection, for obvious computational reasons. In general, regular sampling requires assumptions on band limits. The function W_{ρ} is not band-limited as a function of τ. Therefore, tailored sampling (detector/descriptor) is best suited for the translation group. It should be noted that purported superiority of “dense SIFT” (regularly sampled at thousands of location) compared to ordinary SIFT (at tens or hundreds of detected location), as reported in few empirical studies, is misleading as a comparison has to be performed for a comparable number of samples.

It will therefore be assumed that τ has been tailor-sampled (detected, or canonized), but only up to a localization error. Without loss of generality we assume the sample is centered at zero, and the residual translation τ is in the neighborhood of the origin.

In FIG. 12A through FIG. 12I it was seen that the sensitivity to scale of a common detector (DoG), which should be high, and is instead lower than the sensitivity of the resulting descriptor, which should be low. Therefore, small changes in scale cause large changes in scale sample localization, which in turn cause large changes in the value of the descriptor. Thus, we could forgo scale selection, and instead finely sample the scale. This, however, causes complexity issues, which prompt the need to sub-sample, and correspondingly to anti-alias or aggregate across scale samples. Alternatively, as done in a previous section, we can have a coarse adaptive or tailored sampling of scales, and then perform fine-scale sampling and anti-aliasing around the (multiple) selected scales.

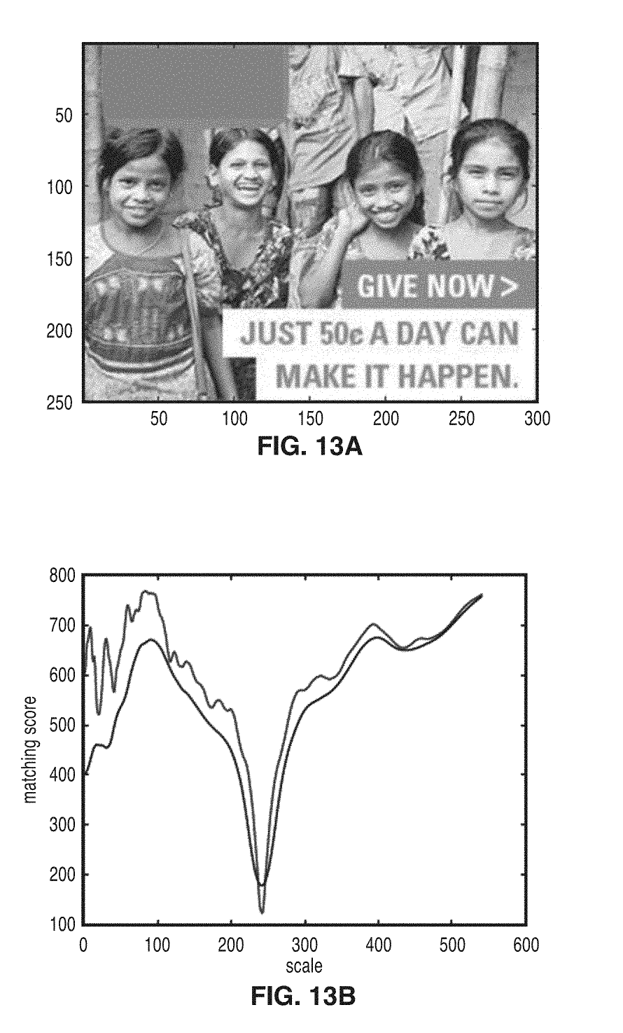

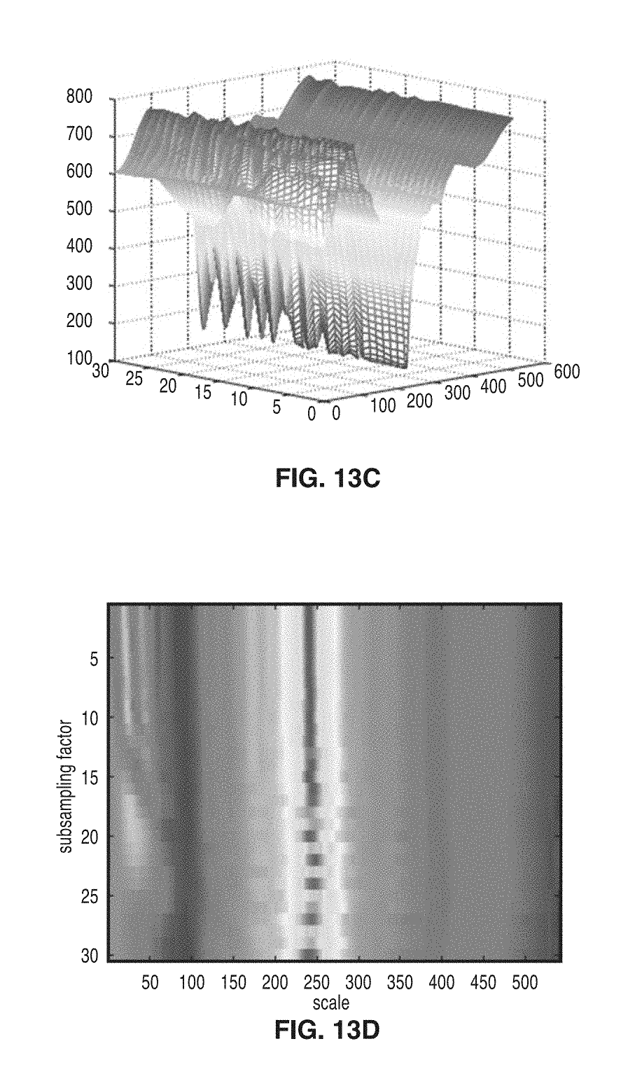

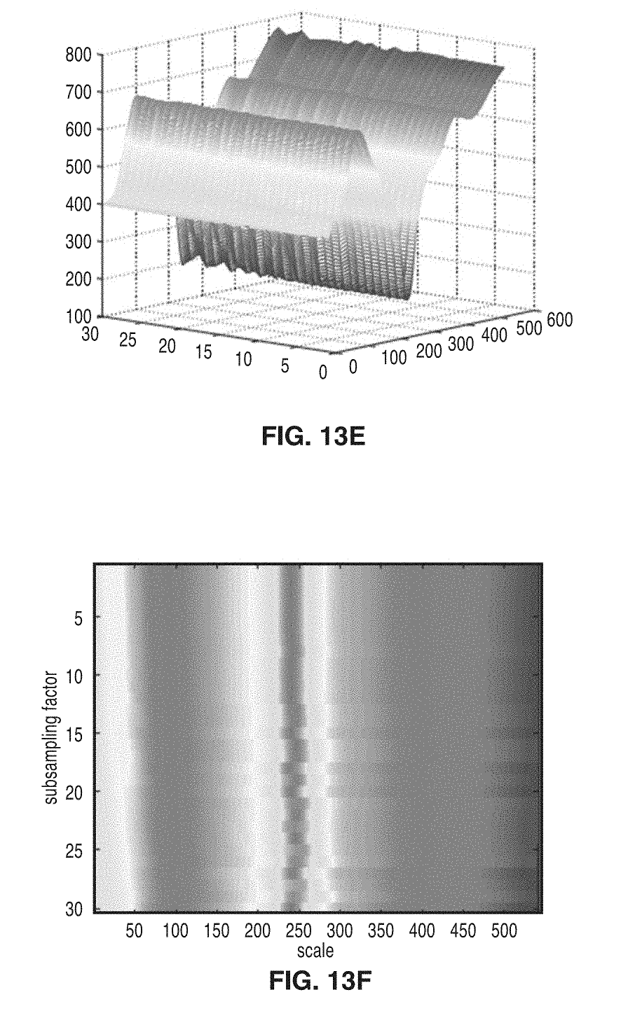

FIG. 13A through FIG. 13F illustrate aspects of aliasing. From FIG. 13A a random row of this image is selected as the target f and re-scaled to yield the orbit [f]; a subset of f, cropped, re-scaled, and perturbed with noise, is chosen as the template ρ. In FIG. 13B the distance E between ρ and [f] is shown in the upper curve as a function of scale. The same exercise is repeated for different sub-sampling of [f], and rescaled for display either as a mesh FIG. 13C or heat map FIG. 13D that clearly show aliasing artifacts along the optimal ridge. Anti-aliasing scale is shown in the mesh of FIG. 13E or the heat map of FIG. 13F producing a cleaner ridge. The net effect of anti-aliasing has been to smooth the matching score E in the lower curve of FIG. 13B but without computing it on a fine grid. Note that the valley of the minimum is broader, denoting decreased sensitivity to scale, and the value is somewhat higher, denoting a decreased discriminative power and risk of aliasing if the value raises above that of other local minima.

Concerning (b), anti-aliasing phenomena appear as soon as Nyquist's conditions are violated, which is almost always the case for scale and domain-size as described above. While most practitioners are reluctant to down-sample spatially, leaving millions of locations to test, it is rare for anyone to employ more than a few tens of scales, corresponding to a wild down-sampling of scale-space. This is true a fortiori for domain-size, where the domain size is often fixed, say to 69×69 or 91×91 locations. And yet, spatial anti-aliasing is routinely performed in most descriptors, whereas none—to the best of our knowledge—perform scale or domain-size anti-aliasing. Anti-aliasing should ideally decrease the sensitivity of the descriptor, without excessive loss of discriminative power. This is illustrated in FIG. 13A through FIG. 13F.

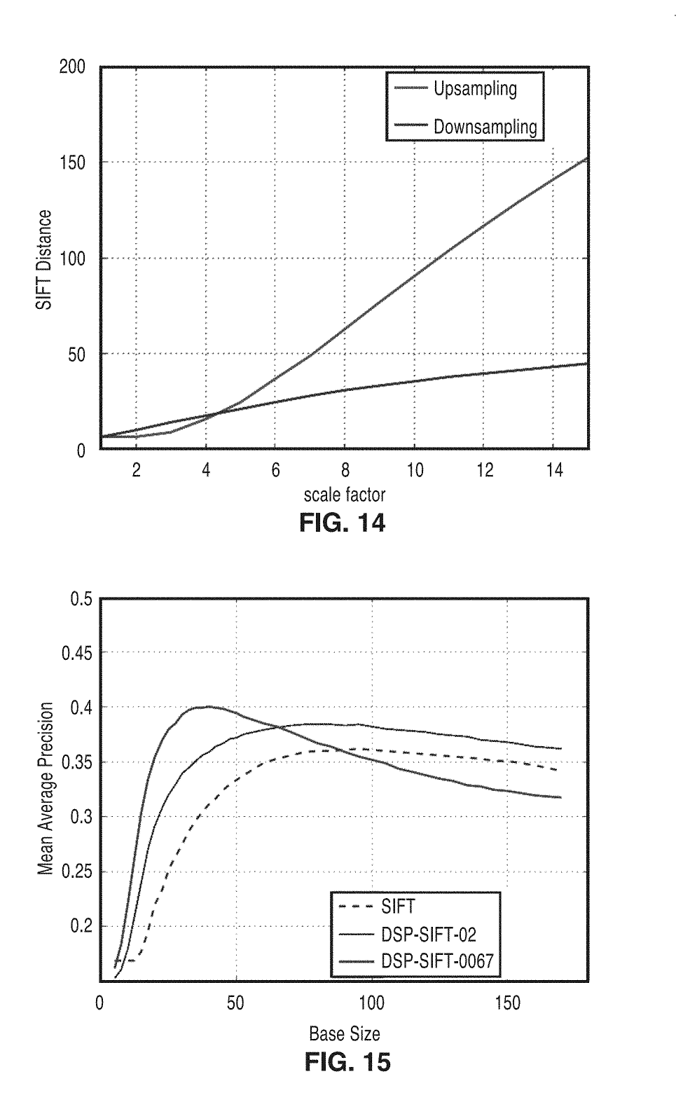

FIG. 14 depicts unidirectionality of mapping over scale, with the upper curve depicting upsampling and the lower curve depicting downsampling. Given two matching patches, one at high resolution, one at low resolution, a comparison can be performed by mapping the high-resolution image to low-resolution by downsampling, or vice-versa mapping the low-resolution to high-resolution by upsampling and interpolation. Scale-space theory suggests that comparison should be performed at the lower resolution, since structures present at the high resolution cannot be re-created by upsampling and interpolation. The figure shows matching distance for matching high-to-low, and low-to-high (average for 2969 random image patches in the Oxford dataset). This is why one should not choose a base region that is too large, such as would cause all smaller regions to be upsampled and interpolated, to the detriment of matching scores. Note that computing descriptors at the native resolution, instead of the corresponding octave in scale-space, is equivalent to choosing a larger base region.

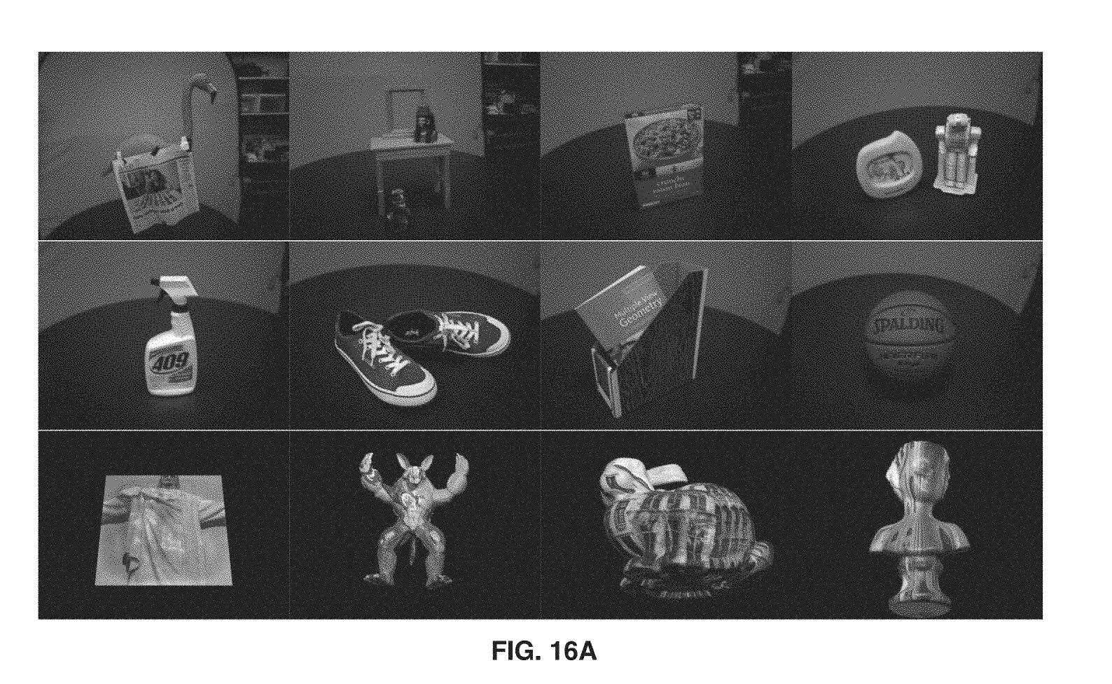

FIG. 15 depicts performance for varying choice of base size, and depicts three curves, a dashed SIFT curve and a DSP-SIFT-02, and DSP-SIFT-067 curve. The base size determines the direction in which comparison over scale is performed, with larger regions correctly mapped down-scale. Smaller regions are mapped up-scale, to the detriment of the matching score. In theory, the larger the base size the better the performance, up to the point where it impinges on occlusion phenomena. This explains the diminishing return behavior shown above. Different base size also affects what normalization threshold should be. We observe that a smaller threshold yields improved performance with the most widely used base size (about 30×30) default in VLFeat.

For (c), choice are made of fixing the domain size in the target (test) image, and regularly sampling scale and domain-size, re-mapping each to the domain size of the target (FIG. 1A through FIG. 1J). For comparison with the cited Fischer reference, we choose this to be 69×69. While the choice of fixing one of the two domains entails a loss, it can be justified as follows. Clearly, the hypothesis cannot be tested independently on each datum f (xᵢ). However, testing on any subset of the “true inlier set” [a, b] reduces the power, but not the validity, of the test. Vice-versa, using a “superset” that includes outliers invalidates the test. However, a small percentage of outliers can be managed by considering a robust (Huber) norm ∥f-Wρ [symbol] instead of the L2 norm. Therefore, one could consider the sequential hypothesis testing problem, starting from each xᵢ ∈[a=b] as an hypothesis, then “growing” the region by one sample, and repeating the test. Note that the optimization has to be solved at each step. In this interpretation, the test can be thought of as a setpoint change detection problem. Another interpretation is that of (binary) region-based segmentation, with a goal to classify the range of a function f-Wρ into two classes, with values coming from either ρ or the background, but the thresholds are placed on the domain of the function [a, b]. Of course, the statistics used for the classification depend on a, b, so this has to be solved as an alternating minimization, but it is a convex one.

As a first-order approximation, one can fix the interval [a, b] and accept a less powerful test (if that is a subset of the actual domain) or a test corrupted by outliers (if it is a superset). This is, in fact, done in most local feature-based registration or correspondence methods, and even in region-based segmentation of textures, where statistics must be pooled in a region.

While (d) is largely an open question, (e) follows directly from classical sampling considerations, as described in a prior section.

7.B.3. Anti-aliasing Descriptors.

In the case of matching images under nuisance variability, it has been shown that the ideal descriptor computed at a location xᵢ is not a vector, but a function that approximates the likelihood, where the nuisances are marginalized. In practice, the descriptor is approximated with a regularized histogram, similar to SIFT. In this case, anti-aliasing corresponds to a weighted average across different locations, scales and domain sizes. But the averaging in this case is simply accomplished by pooling the histogram across different locations and domain-sizes. The weight function can be designed to optimize the tradeoff between sensitivity and discrimination, although in a previous section a simple uniform weight was utilized by way of example and not limitation.

To see how pooling can be interpreted as a form of generalized anti-aliasing, consider the function f sampled on a discretized domain f(xᵢ) and a neighborhood βσ(xᵢ) (for instance the sampling interval). The pooled histogram is

$${p}_{{x}_{i}} ( y ) = \frac{1}{σ} {\sum }_{{x}_{i} ε {ℬ}_{σ} ( {x}_{i} )} δ ( y - f ( {x}_{j} ) ) \qquad ( 9 )$$

whereas the anti-aliased signal (for instance with respect to the pillbox kernel) is

$$φ ( {x}_{i} ) = \frac{1}{σ} {\sum }_{{x}_{j} ε {ℬ}_{σ} ( {x}_{i} )} f ( {x}_{j} ) \qquad ( 10 )$$

The latter can be obtained as the mean of the former

φ(xᵢ)=Ξ_{y} ypₓ_{ᵢ}(y) (11)

although the former can be used for purposes other than computing the mean (which is the best estimate under Gaussian (l²) uncertainty), for instance to compute the median (corresponding to the best estimate under uncertainty measured by the l¹ norm), or the mode:

$$\hat{f} ( {x}_{i} ) = arg {max}_{y} {p}_{{x}_{i}} ( y ) \qquad ( 12 )$$

The approximation is accurate only to the extent in which the underlying distribution px(y)=p(f(x)=y) is stationary and ergodic (so the spatially pooled histogram approaches the density), but otherwise it is still a generalization of the weighted average or mean.

This derivation also points the way to how a descriptor can be used to synthesize images. Simply by sampling the descriptor which is thought of as a density for a given class. It also suggests how descriptors can be compared, rather than computing descriptors in both training and test images, a test datum can just be fed to the descriptor to yield the likelihood of a given model class without computing the descriptor in the test image.

7.C. Effect of the Detector on the Descriptor.

A detector is a function of the data that returns an element of a chosen group of transformations, the most common being translation (e.g., FAST), translation-scale (e.g., SIFT), similarity (e.g., SIFT combined the direction of maximum gradient), affine (e.g., Harris-affine). Once transformed by the (inverse of) the detected transformation, the data is, by construction, invariant to the chosen group. If that was the only nuisance affecting the data, there would be no need for a descriptor, in the sense that the data itself, in the reference frame determined by any co-variant detector, is a maximal invariant to the nuisance group.

However, often the chosen group only captures a small subset of the transformations undergone by the data. For instance, all the groups above are only coarse approximations of the deformations undergone by the domain of an image under a change of viewpoint. Furthermore, there are transformations affecting the range of the data (image intensity) that are not captured by (most) co-variant detectors. The purpose of the descriptor is to reduce variability to transformations that are not captured by the detector, while retaining as much as possible of the discriminative power of the data.

In theory, so long as descriptors are compared using the same detector, the particular choice of detector should not affect the comparison. In practice, there are many second-order effects where quantization and unmodeled phenomena impact different descriptors in different manners. Moreover, the choice of detector could affect different descriptors in different ways. The important aspect of the detector, however, is to determine a co-variant reference frame where the descriptor should be computed.

In standard SIFT, image gradient orientations are aggregated in selected regions of scale-space. Each region is defined in the octave corresponding to the selected scale, centered at the selected pixel location, where the selection is determined by the SIFT detector. Although the size of the original image subtended by each region varies depending on the selected scale (from few to few hundred pixels), the histogram is aggregated in regions that have constant size across octaves (the sizes are slightly different within each octave to subtend a constant region of the image). These are design parameters. For instance, in VLFeat they are assigned by default to 30×30, 38×38, 48×48. In a different scale-space implementation, one could have a single design parameter, which we can call “base size” σ0 for simplicity.

In comparing with a convolutional neural network, the previously cited Fischer reference chose patches of size 64×64 and 91×91 (which we call σ*) in images of maximum dimension <1000. This choice is made for convenience in order to enable using pre-trained networks. They use MSER to detect candidate regions for testing, rather than SIFT's detector. However, rather than using the size of the original MSER to determine the octave where SIFT should be computed, they pre-process all patches to size σ*. As a result, all SIFT descriptors are computed at the same octave σ*/σ0×1.6=4.8, rather than at the scale determined by the detector. This short-changes SIFT, as some descriptors are computed in regions that are too small relative to their scale, and others too large.

7.D. Choice of Domain for Comparison with CNNs.

One way to correct this bias would be to use a* as the base size.

However, this would yield an even worse (dataset-induced) bias: A base size of 91×91 in images of maximum dimension <1000 means that any feature detected at higher octaves encompasses the entire image. While discriminative power increases with size, so does the probability of straddling an occlusion: The power of a local descriptor increases with size only up to a point, where occlusion phenomena become dominant (FIG. 11). This phenomenon is evident even in Oxford and Fischer's datasets despite them being free of any occlusion phenomena. Note that while the cited Fischer reference allows regions of size smaller than 91×91 to be detected (and scale them up to that size), in effect anything smaller than 91×91 is considered at the native resolution, whereas using the SIFT detector would send anything larger than σ0 to a higher octave.

A more effective way to correct the bias is to use the detector in its proper role, in particular determining a reference frame with respect to which the descriptor is computed. For the case of MSER, this consists of affine transformations. Therefore, the region where the descriptor is computed is centered, oriented, skewed and scaled depending on the area of the region detected. Rather than arbitrarily fixing the scale by choosing a size to which to re-scale all patches, regions of different size are selected, and then each is assigned a scale which is equal its area divided by the base size σ0. In this way the octave where SIFT is computed is determined.

In any case, regardless of what detector is used, DSP-SIFT is primarily concerned with where to compute the descriptor: Instead of being computed just at the selected size, however it is chosen, it should be computed for multiple domain sizes. But scales have to be selected and mapped to the corresponding location in scale-space. There, SIFT aggregates gradient orientation at a single scale, whereas DISP-SIFT aggregates at multiple scales.

8. Multi-View Feature Engineering and Learning.

8.1. Introduction.

For visual data, a “feature descriptor” is a function of images designed to be “insensitive” to nuisance variability and yet “discriminative” with respect to intrinsic properties of the scene or object of interest. Nuisance variability may be due to changes of viewpoint and illumination, and intrinsic properties include three-dimensional shape and material properties of the scene, or object-specific deformations. The best-known local descriptors are SIFT, HOG and their variants, which we refer to herein collectively as HoG (histogram of gradient). For an image region centered at a point, these local descriptors are histograms of the orientation of its gradient in that region, variously normalized.

On the other hand, representation learning via neural networks construct functions that are insensitive to nuisance variability by training a convolutional architecture supported on the entire image domain. There have been several studies of the empirical performance of local feature descriptors, including their comparison, and their generative abilities. However, efforts to elucidate their relationships have only recently begun to appear.

But what is an ideal representation? In terms of being “discriminative” of the intrinsic properties of the scene, such as its shape and reflectance, one could do no better than a (minimal) sufficient statistic, for instance the likelihood function. In terms of being “insensitive” to nuisance factors, such as viewpoint and illumination, one could do no better than a (maximal) invariant to their action on the data. So, an ideal representation would be a minimal sufficient statistic that is maximally invariant to nuisance factors.

Does such a representation exist? If so, can it be computed? If not, can it be approximated? Can existing descriptors be related to it? If so, under what conditions? If not, how can we construct better approximations of an ideal representation?

8.1.1. Related Work.

There are many engineered descriptors of one image, that differ on where and how the local histograms are aggregated and normalized, with many implementation details affecting performance. Some entail learning to minimize classification (correspondence) error. Relatively few local descriptors aggregate multiple views. Deformable parts models are also learned from multiple views to capture intrinsic variability.

One could also learn away nuisance variability through a neural network architecture. This approach has been steadily improving performance in large-scale pattern recognition, but not in correspondence, where it is outperformed by engineered descriptors, even some built using a single image. Rather than performing direct comparison between different descriptors, in this portion of the disclosure an ideal local representation is instantiated relative to a simple image-formation (Lambert-Ambient, or LA) model, and relate various descriptors to it.

8.1.2. Summary.

To quantify how “discriminative” a descriptor is, its dependency on intrinsic properties of the scene is characterized, namely shape S and reflectance ρ. It should be appreciated that in the LA model S ⊂ [symbol] is a multiply-connected piecewise smooth surface in Euclidean space, and ρ: S→ [symbol] is a positive-valued scalar function called “albedo.” As we model illumination via contrast transformations of the albedo, we interpret p modulo contrast changes as the reflectance of the surface S. To quantify how “insensitive” it is, the disclosed method describes its dependency on nuisance factors such as viewpoint and illumination. The LA model has been described as the simplest to capture the phenomenology of image formation for the purpose of correspondence. Local illumination changes are modeled, to first-order approximation, as monotonic continuous transformations of the range of the image, also known as contrast transformations. They form a group, and under certain conditions the gradient orientation is a maximal invariant. It will be noted that the group, if strictly monotonic can form a monoid. So we can eliminate first-order dependency on illumination by replacing the image I with its gradient orientation θ(x)=∠∇I(x)=∇I(x)/∥∇I(x) ∥, at locations x where ∇I(x)≠0. It should be noted that in replacing the image I: D ⊂ [symbol] → [symbol] ⁺; x [symbol] I(x) is a gray-scale image, x ∈ D is a point on the plane. In practice, I takes a finite number of values on a quantized domain, extended to the entire plane by zero-padding. For a local neighborhood [symbol] ⊂ [symbol] ², the likelihood function, computed at a location x ∈ [symbol] and conditioned on a given shape S and reflectance ρ, is a minimal sufficient statistic, and can be thought of as a probability density on θ, [symbol] (θ|I ρ, S) with marginals pₓ(θ|ρ, S). It should be noted that if we knew the viewpoint, under the assumptions of the LA Model, the conditional density would be spatially independent; otherwise, marginalizing viewpoint introduces spatial dependency, so the product of the marginals is only an approximation. If there are additional groups G acting on the scene (for instance changes of spatial position and orientation, G=SE(3)) they can be marginalized, thus obtaining a density

P_{x,G}(θ|ρ,S) (13)

The marginalized likelihood is a maximal contrast-invariant that is also G-invariant. With respect to this ideal representation, our goals are to: (i) Instantiate the formal notation above using the LA model and derive an expression for (Eq. 1) suitable for computation. (ii) Shows that HoG approximates an ideal descriptor when the scene is planar and the viewer is constrained to translating parallel to it. (iii) Derive a sampling approximation of (Eq. 13), which we call MV-HoG, where the scene (S, ρ) is replaced with a collection of images of it, captured from multiple viewpoints {Iₜ}ₜ₌₁^{T}. (iv) Derive a point-estimate based approximation, which we call R-HoG, where the scene (S, ρ) is replaced with a point estimate (Ŝ, \hat{ρ}) reconstructed from a finite sample possibly using structured illumination.

8.2 Engineered Features Revisited.

A “cell” of the HOG/SIFT descriptor h of an image I in a region centered at a pixel x is a histogram of the orientation of its gradient, θ, around x. It will be noted here that θ∈ [symbol] is an angle (the free variable) and h:D× [symbol] ¹→ [symbol] ⁺;(x, θ) [symbol] hₓ(θ) for a fixed image I. If the histogram is not normalized, we call it uHoG (un-normalized HoG) and indicate it with

hₓ(θ|I) uHoG (14)

Given one image I, this un-normalized histogram returns a positive number for each orientation θ, related to the number of pixels around x where the image gradient orientation is close to θ. Variants of HoG differ in where they compute and how they aggregate and normalize such histograms. For instance, SIFT evaluates the histogram above on a 4×4 grid [symbol] ={xᵢ, i=1, . . . , 16} and concatenates the result into a vector [hₓ_{₁}, . . . , hₓ_{₁₆}], that is then normalized, clamped, and re-normalized. Discrete bins are computed using a bilinear interpolation kernel κ_{∈}with Å=2π/ #bins,and a linear spatial weighting kernel κ_{σ}, with a the area of each cell in the 4×4 grid, further weighted by the magnitude of the image gradient ∥∇I ∥. If we extend the sum to the continuum, we can write the histogram in each cell:

hₓ(θ|I)=∫κ_{∈}(θ−∠∇I(y)κ_{θ}(x−y)∥∇I(y)∥dy (15)

where the argument of the orientation kernel is intended modulo 2π. Alternatively, histograms can be normalized independently at each location x:

$${\overline{h}}_{x} ( θ \vert I ) = \frac{{h}_{x} ( θ \vert I )}{{\int }_{{𝕊}^{1}} {h}_{x} ( θ \vert I ) d θ} , h = [ {{h}_{x}}_{1} , {h}_{{x}_{2}} , … , {h}_{{x}_{i}} , … ] \qquad ( 16 )$$

Note that in HoG, described above, the nuisance group G is absent, and is introduced next.

8.2.1. Ideal Descriptor of one View and its HoG.

As a preliminary step to computing the minimal sufficient invariant statistic, and to understand its relation to single-view descriptors, consider a special case obtained by assuming that the scene is a plane parallel to the image plane, with albedo equal to the image irradiance. Then, conditioning on the image I, we have p_{x,G}(θ|I), which we wish to relate to uHoG (Eq. 14).

To guarantee contrast-invariance, one could replace the intensity with I(x) ∈ [symbol] ⁺ the curvature of the iso-contours, or with its dual, the orientation of the gradient, ∠∇I(x)∈ [symbol] ¹ where ∇I(x)≠0. Let (G, P) be a probability space, with G a group and P a probability distribution on the group, and suppose that to each g ∈ G we can associate a “transformed” image I_{g}. For each pixel x ∈ [symbol] where ∇I_{g}(x)≠0, we can then define a (marginal) probability density function over θ, for instance:

p_{x,G}(θ|I,g)≐ [symbol] _{∈}(θ−∠∇I_{g}(x)) (17)

where the difference is intended in [symbol] ^{l}, and correspondingly [symbol] _{∈} denotes an angular Gaussian. Kernels κ other than Gaussian can also be considered without significant changes to the arguments that follow. Using P, we can marginalize this distribution. It should be noted that this integral is well defined by Fubini's theorem; p_{x,G}(θ|I,g) is a measurable function of g and bounded so the marginalization converges. Thus, we can integrate over θ and exchange the integrals. But while marginalization guarantees invariance to g ∈ G, it does not yield a maximal invariant. So then, using P, this distribution is marginalized to eliminate its dependency on g ∈ G:

P_{x,G}(θ|I)≐∫_{G} p_{x,G}(θ|I,g)dP(g) (18)

To understand the relationship with uHoG, our method restricts G to be the group planar translations, G= [symbol] , and chooses a particular measure for [symbol] ², dμ(v|I)≐∥∇Iᵥ(x)∥dv where, if v ∈ G,Iᵥ(x)=I(x+v) is the transformed image. We then marginalize with respect to the (un-normalized) distribution dP(v)= [symbol] _{σ}(v)dμ(v|Iᵥ). This corresponds to assuming that the scene is flat, parallel to the image-plane (fronto-parallel) and constrained to translate parallel to it. The likelihood function is given by P_{x,G}(θ|I,v)= [symbol] (θ−∇|Iᵥ(x)). Integrating against dP(v), we obtain:

hₓ(θ|I)=∫_{G}P_{x,G}(θ−∇|ᵥ)dP(v)= [symbol] [symbol] _{ε}(θ−∠∇|ᵥ(x) [symbol] _{σ}(v)dμ(v|Iᵥ)=

[symbol]

[symbol]

_{ε}(θ−∠∇I(y) [symbol] _{σ}y−x)∥∇I(y)∥dy (19)

which is one cell of uHoG (Eq. 15) once we restrict to the discrete lattice and replace the Gaussian kernels with (bi-)linear ones. The full descriptor is just the concatenation of a number of cells, suitably normalized; for the case of a single cell,

$${p}_{x , G} ( θ \vert I ) = \frac{{h}_{x , G} ( θ \vert I )}{\int {h}_{x , G} ( θ \vert I ) d θ} \qquad ( 20 )$$

which leads us to conclude that HOG/SIFT approximates the ideal representation at a point under the assumption that the scene is flat and fronto-parallel, undergoing purely translational motion parallel to the image plane.

8.3. Ideal Descriptor Approximations.

To move one step closer to the ideal representation, and to relax the stringent assumptions implicit in HOG/SIFT, suppose for now that we have complete knowledge of the underlying scene (S, ρ). A pinhole camera projects each point on the scene to the image plane via π: S→D⊂ [symbol] ² and its associated inverse π_{S}⁻¹: D→S, where π_{S}⁻¹(x) is the point of the first intersection of the pre-image (a line) of x with the scene S. It will be noted that π incorporates the projection by dividing the coordinates of a point in S by the third component and applying a planar affine transformation depending on the intrinsic calibration of the camera.

In view of the above, under the assumptions of the LA model, there exists an open subset G₀⊂SE(3) with compact closure and—after a suitable change of reference frame—containing the identity, such that each g ∈ G₀, with the action

I_{g}(x)=p∘g∘πₛ⁻¹(x) (21)

can be associated with a domain diffeomorphism w_{g}: [symbol] ²→ [symbol] ², with I_{g}(x)=I(w_{g}(x)). Here “∘” denotes function composition. When emphasizing the dependency of w_{g} on shape, we indicate it with w_{g}(x|S). Let P be a probability measure on G0, e.g., the normalized restriction of the Haar measure on SE(3) to G0, which is no longer a group, but a subset of G, where the probability of actions outside G0 is assigned to zero. Then the marginalized descriptor, for a known scene, is given by

P_{x,G}_{₀}(θ|ρ,S)=∫_{G}_{₀} [symbol] _{ε}(θ−∠∇ρ∘g∘π_{S}⁻¹(x))dP_{G}_{₀}(g)=∫_{G}_{₀} [symbol] _{ε}(θ−

∠∇I(w_{g}(x|S)))dP_{G}_{₀}(g) (22)

The first approximation step is to reduce the dimensionality of G₀ ⊂SE(3)=SO(3)× [symbol] ³ to simplify marginalization. This can be done locally around a point π_{S}⁻¹(x) through the use of a co-variant detector, a function of the image that returns multiple isolated elements of subsets of G0 that co-vary with g. For instance, a translation-scale detector returns isolated locations on the image plane, xᵢ, and their corresponding scales σᵢ, which can be used to define a local reference frame centered at xᵢ with unit σᵢ. To first approximation, as we qualify in the next paragraph, these co-vary with the translation component of G0: A spatial translation parallel to the image plane induces a planar translation of xᵢ, and a spatial translation orthogonal to the image plane induces a change of scale σᵢ. Thus, locally around π_{S}⁻¹(xᵢ) we can annihilate the effects of spatial translation simply by canonizing the location-scale group, i.e., imposing xᵢ=0, σᵢ=1, by applying the inverse transformation of that determined by the co-variant detector. This procedure can be applied to any planar group transformation, including the entire group of diffeomorphisms. In particular, planar rotation can be canonized using the direction of gravity as a reference, leaving only “out-of-plane” rotations to be marginalized as in Eq. 22.

In reality, spatial translations do not co-vary with planar translation-scale transformations, for the former induces (shape-dependent) deformations of the image domain (Eq. 21) in addition to non-invertible transformations due to occlusions, which are absent in the latter. Such shape-dependent image variability is lost in any descriptor computed from a single image. Thus, any finite-dimensional planar group-covariant detector co-varies with spatial translations only when the scene is flat and the neighborhood of size σᵢ centered in xᵢ, [symbol] _{σ}_{ᵢ},(xᵢ) does not straddle occluding boundaries. Fortunately, we are not constrained to building descriptors using a single image; instead, we can capture residual deformations after canonization by marginalizing with respect to out-of-plane rotations in S0(3). In addition, we can also marginalize small residual changes in translation v and scale σ using some prior P [symbol] σ×P_{ε}_{ₛ}, where d [symbol] (v)= [symbol] _{σ}(v)dμ(v) and d [symbol] (σ)=εₛ(σ)dσ with ε a unilateral density (e.g., exponential) to ensure σ>0. It should be noted that this approximation step does not reduce the generality of the approach: In practice, one would have to discretize the group G0 anyway in order to perform the marginalization in Eq. 22, and co-variant detectors are just an adaptive discretization mechanism. A trivial detector is one that returns regular samples of the group, for instance a discretization of planar translations and scales as customary in “dense SIFT.” Indeed, this discretization is necessary also to compactify the translational component of G0, that otherwise would have to be marginalized with respect to an improper measure.

Thus, in view of the above our un-normalized conditional distribution becomes:

h_{x,G}(θ|ρ,S)=∫_{G}_{₀} [symbol] _{ε}(θ−∠∇I_{g}(x))dP_{G}_{₀}(g)≃

∫ [symbol] _{ε}(θ−∠∇I(w_{g}(y)))dP_{SO(3)}(g) [symbol] _{σ}(y−x))εₛ(σ)dμ(y)dσ (23)

If out-of-plane rotations are neglected, or if the scene is planar, one image is sufficient to construct an idea descriptor, which then reduces to DSP-SIFT, described in sections 1-7. To obtain the ideal descriptor of a region [symbol] , one must consider the joint distribution of all pixels within: hₓ_{₁}_{^{, . . . , x}}_{ₖ}_{^{G}}(θ, . . . , θₖ|ρ, S). Aggregating histograms in high dimensions is challenging but the joint distribution can be approximated by a collection of one-dimensional marginals. The simplest approximation is to neglect spatial correlations altogether: From Eq. 22,

Px₁, . . . , xₖG₀(θ₁, . . . , θₖ|ρ,S)=∫_{G}_{₀}Πᵢ₌₁^{k} [symbol] _{ε}(θᵢ−∠∇I(w_{g}(xᵢ|S)))dp_{G}_{₀}(g)≃

Πᵢ₌₁^{k}hₓ_{ᵢ}_{^{,G}}(θᵢ|ρ, S) (24)

As already pointed out, under the assumptions of the LA model, if the vantage point g ∈ SE(3) was known, then the conditional density above would indeed factorize into the product of marginals computed independently at each pixel. However, marginalizing viewpoint introduces spatial dependencies, so the above is just an approximation. As coarse as it seems, this is nevertheless the approximation implicit in most single-view descriptors, that consider the concatenation of (independently aggregated, scalar) histograms. Some single-view descriptors attempt to recapture some of the lost spatial correlations by joint (re)-normalization. Even this approximation, however, requires knowledge of the scene (S, ρ) to be computed. We now address how to cope with absence of such knowledge.

8.3.1. Sampling approximation: MV-HoG.

If we do not have complete knowledge of the scene, (S, ρ) , but we have a collection of images of it {Iₜ}ₜ₌₁^{T}, we can approximate Eq. 23 by Monte-Carlo sampling, after noticing that Iₜ(x)=ρ∘gₜ∘π_{S}⁻¹(x)=I(w_{g}_{ₜ}(x)) with {w_{g}_{ₜ}|t=1, • • • ,T} and gₜ˜P_{G}_{₀} with the restriction G₀ determined by visibility. Under sufficient excitation conditions on the sample {Iₜ}ₜ₌₁^{T}, asymptotically for T→∞, we can approximate the integral with:

$${h}_{x , G} ( θ \vert {\{ {I}_{t} \}}_{t = 1}^{T} ) ≐ {\sum }_{t = 1}^{T} {\int }_{{ℝ}^{2}} {𝒩}_{ɛ} ( θ - ∠ ∇ {I}_{t} ( y ) ) {𝒩}_{σ} ( y - x ) d μ ( y ) .$$

Scale a can also be marginalized as in Eq. 23. Sufficient excitation conditions mean that the orbit in SE(3) is sampled along all directions (in the Lie Algebra), which is a difficult task, as it requires every surface element to be seen from all vantage points, at all distances, while gₜ remains in G0. This requirement can be mitigated by restricting the marginalization to S0(3) or even to just out-of-plane rotations, using Eq. 23 in conjunction with a co-variant detector or other sampling mechanism.

Alternatively, we can use whatever data is available to reconstruct a model (a point estimate) of the scene, which can then be used to render synthetic samples from the orbits of SE(3).

8.3.2 Point-estimate Approximation: R-HoG.

Samples {Iₜ} can be used to compute an approximation of ρ, S, for instance in the sense of maximum-likelihood, with suitable regularization

$$\hat{ρ} , \hat{S} = arg {max}_{ρ , S , {g}_{t}} p ( \{ {I}_{t} \} \vert ρ , S ) + λ R ( S ) subject to \\ {I}_{t} = ρ ∘ {g}_{t} ∘ {π}_{S}^{- 1} + {n}_{t} \qquad ( 25 )$$

where R(S) is, for instance, surface area ∫ₛ dA, nₜ is white and Gaussian, and λ is a scalar multiplier, and then compute Eq. 22 restricted to out-of-plane rotations

h_{x,G}(θ|\hat{ρ},Ŝ)=∫_{SO(3)} [symbol] _{ε}(θ−∠∇\hat{ρ}∘g∘π_{Ŝ}⁻¹(y))dP_{SO(3)}(g) (26)

or its spatially regularized version:

h_{x,G}(θ|\hat{ρ},Ŝ)= [symbol] [symbol] _{ε}(θ−∠∇\hat{ρ}∘g∘π_{Ŝ}⁻¹(y))dP_{SO(3)}(g) [symbol] _{σ}(y−x)dμ(y)

or its scale-marginalized version as in Eq. 23. Convergence and unbiasedness of the maximum-likelihood estimator ensures convergence of R-HoG to Eq. 23. Note that it is possible for the reconstruction to be significantly different from S and yet R-HoG be similar to the ideal descriptor, so long as the re-projections \hat{ρ}∘g∘π_{Ŝ}⁻¹(x) are compatible with w_{g}_{ₜ},(x|S). This can happen, for instance, when Ŝ differs from S in regions where ρ is constant. Also note that, in theory, two views with non-trivial baseline are sufficient to reconstruct an approximation of Ŝ and \hat{ρ}”, locally in the co-visible region. Therefore, R-HoG is preferable when T is small and the sample is unlikely to be sufficiently exciting. Normalized versions of each descriptor are obtained as

$$p ( θ \vert X ) = \frac{{h}_{x , G} ( θ \vert X )}{\int {h}_{x , G} ( θ \vert X ) d θ} \qquad ( 27 )$$

where X=I for HOG, X={Iₜ} for MV-HoG, X={\hat{ρ}, Ŝ} for R-HoG, and X=(ρ, S) for the ideal descriptor that marginalizes the nuisance assuming a known scene.

While MV-HoG had a stringent sampling requirement, R-HoG has its own challenges, in that obtaining a reliable, dense reconstruction of a scene and its photometry can be difficult. However, an estimate of the surface is only needed locally, where smooth surfaces can be approximated with parametric models of low order. Also, calibrated reconstruction is not necessary, so a projective reconstruction can be obtained through solving systems of linear equations. Alternatively, a structured model can be inferred through factorization methods such as principal component analysis or sparse coding, whereby S is represented by the coefficients of a linear combination of a collection of “basis elements” {Sᵢ}.

8.4. Dataset and Ground Truth.

Since our focus here is to leverage on multiple views to build better descriptors, which can then be matched to single-images in wide-baseline tests, to perform comparisons we need a dataset where multiple training images (of the same scene) are available, whereas correspondence testing can be performed on single images.

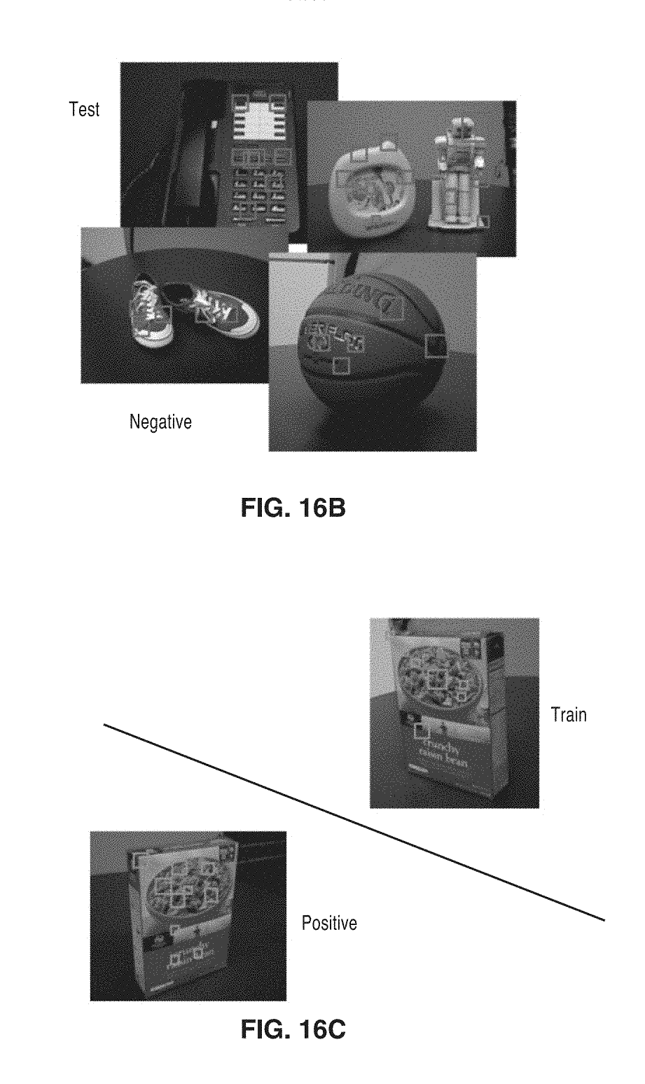

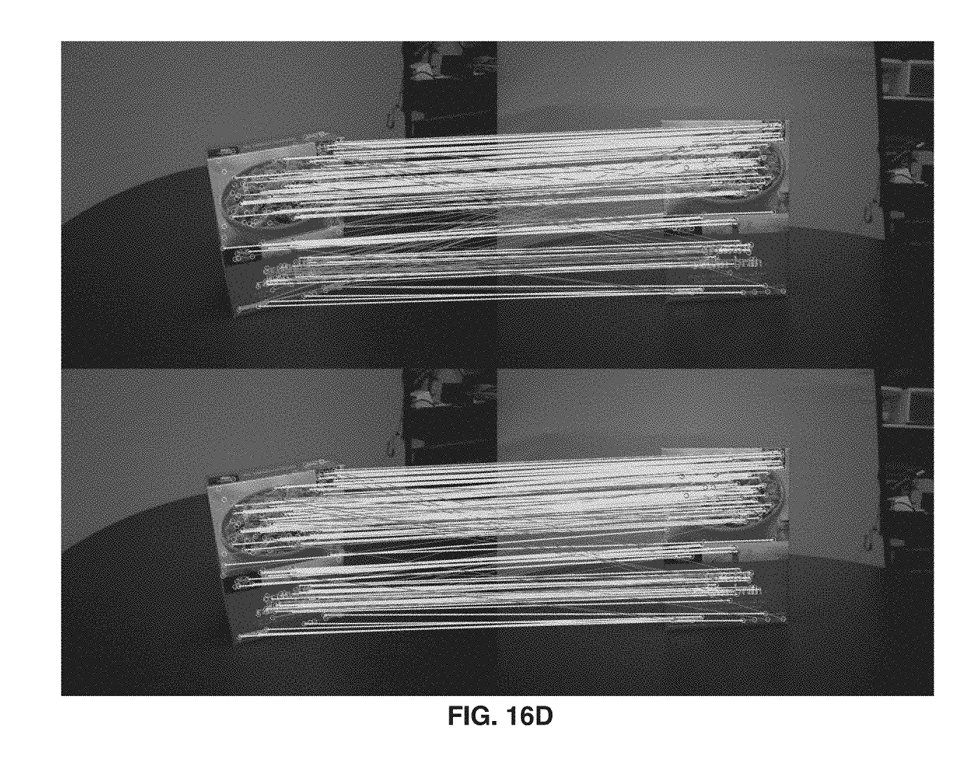

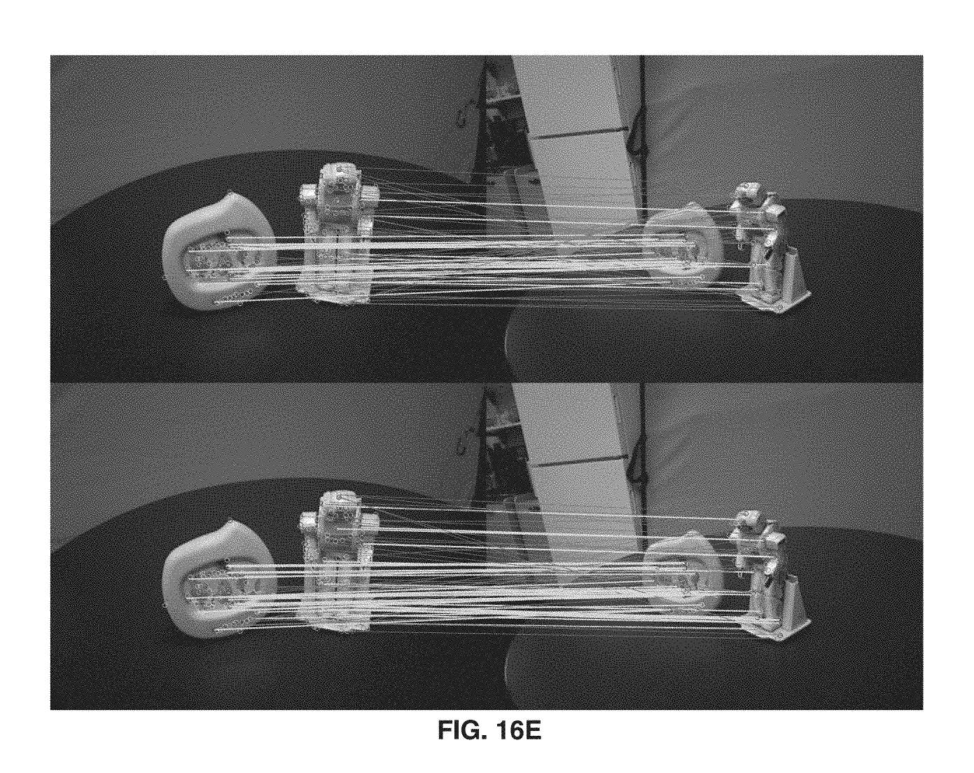

FIG. 16A through FIG. 16E illustrate examples of dataset, test samples and qualitative match visualization. In FIG. 16A samples (12 images) from the real and synthetic object dataset are shown. In FIG. 16B a positive test sample from the object is seen with negative samples which are ten-fold more numerous. In FIG. 16D and FIG. 16E correct and incorrect matches (depicted by different line shading, claimed by SV-SIFT in the upper images and by MV-HoG in the lower images. The latter yields many more correct matches, similar to R-HoG.

Many datasets are available to test image-to-image matching where both training and test sets are individual images, each of a different scene. Testing our approach on such datasets would require forgoing marginalization of out-of-plane rotation, thus reducing our approach to DSP-SIFT.

Fewer datasets are available for testing multi-view descriptors. The latter contains three scenes: Trevi, Half Dome and Notre Dame and provides pixel-level correspondence by back-projecting 3D reconstructed keypoints onto images, which can be used for evaluation. To enable the comparison, we extract a subset containing only features having more than 10 samples. We randomly hold out 5 samples for testing and use the rest for descriptor aggregation. Negative samples are randomly selected from the other scenes.

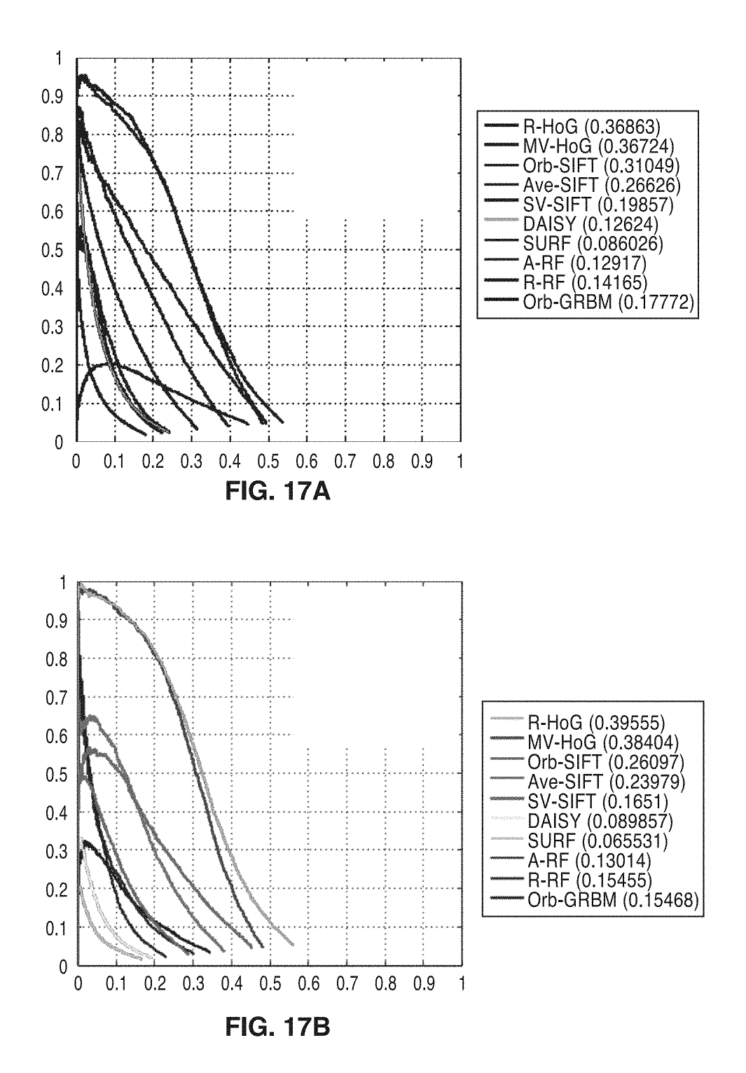

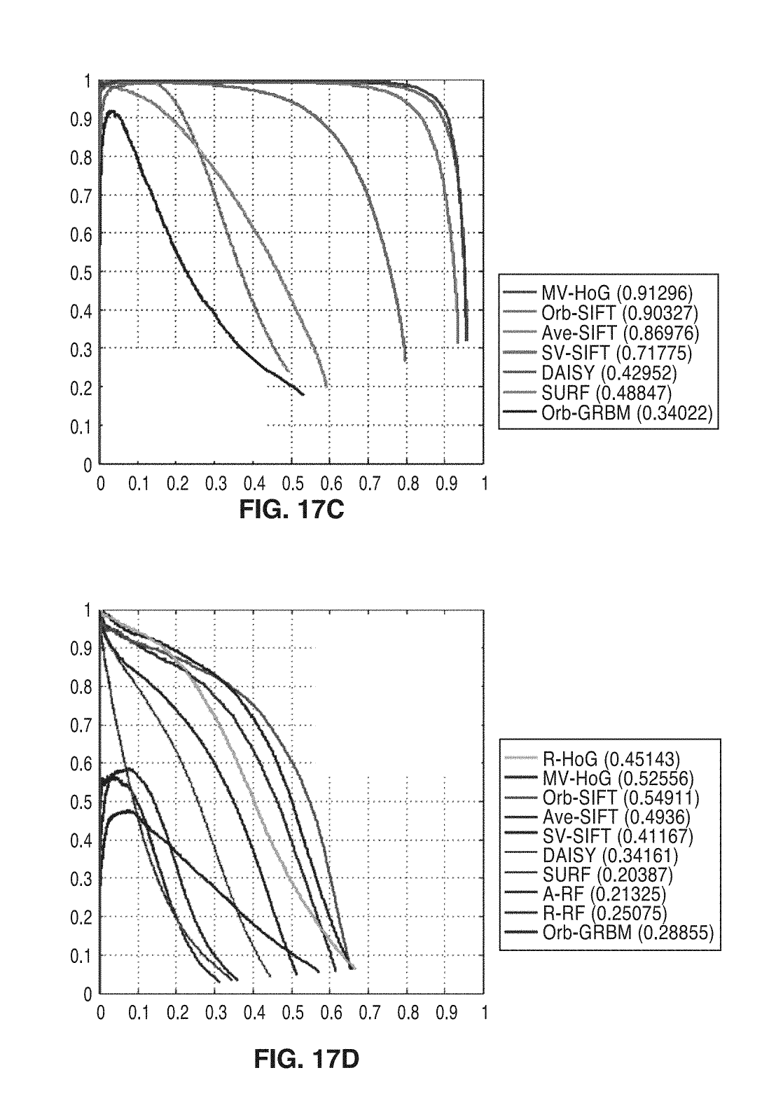

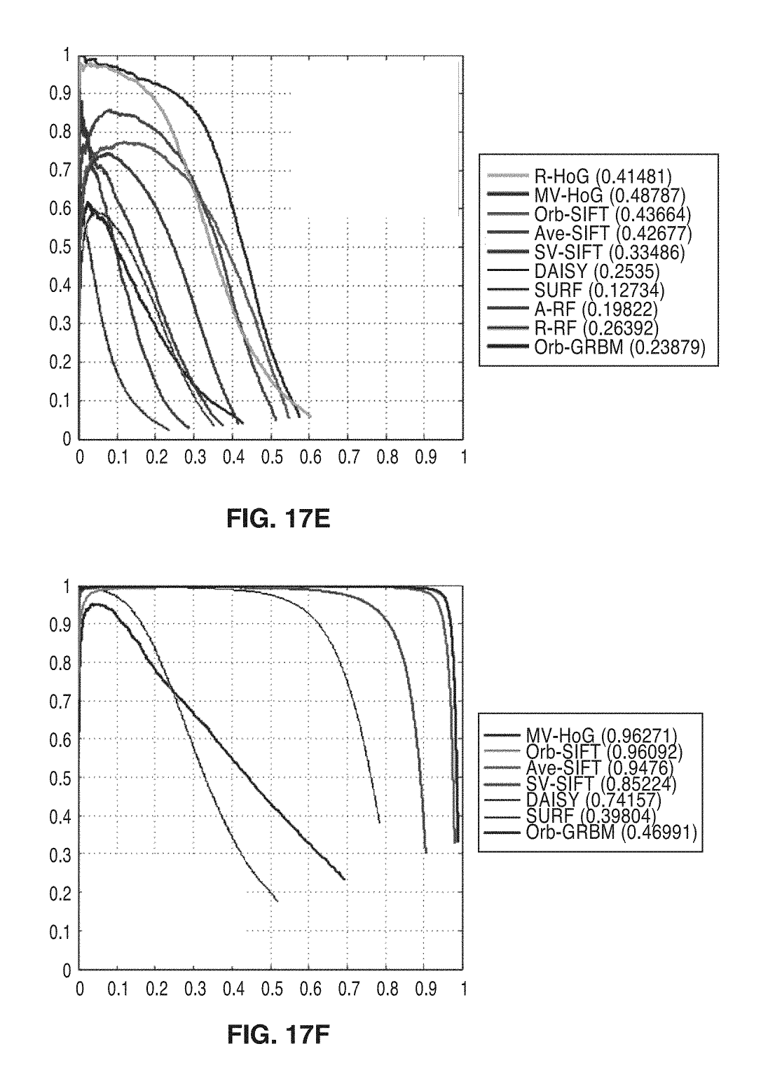

FIG. 17A through FIG. 17F depict precision-recall curves for descriptors R-HoG, MV-HoG, Orb-SIFT, Ave-SIFT, SV-SIFT, DAISY, SURF, A-RF, R-RF, and Orb-GRBM. In these plots, the precisions (ordinate) are seen over recall rates (abscissa) with F1-scores in the legends. FIG. 17C and 17F are datasets associated with the paper (S. A. Winder and M. Brown. Learning local image descriptors. In Proceedings of IEEE Conference on Computer Vision & Pattern Recognition, pages 1-8, 2007). It can be seen that almost perfect results are obtained in FIG. 17C and FIG. 17F, thus limiting the value of the dataset; we have therefore constructed a new dataset, with a separate test set and dense ground truth for validation, using a combination of 31 real and 15 synthetic objects. The latter are generated by texture-mapping random images onto surface models available in MeshLab. The former are household objects of the kind seen in FIG. 16A. Some of these images have significant texture variability, others with little; some with complex shape and topology, others simple. In each case, a sequence of (training) images per object is obtained by moving around the objects in a closed trajectory. For real objects, a 400-frame-trajectory circumnavigates them to reveal most visible surfaces; for synthetic ones, 100 frames span a smaller orbit.

Ground Truth: We compare descriptors built from the (training) video and test single frames, by first selecting test images where a sufficient co-visible area is present. To establish ground truth, we reconstruct a dense model of each (real) object using an RGB-D (structured light) range sensor with YAS (J. Balzer, M. Peters, and S. Soatto. Volumetric reconstruction applied to perceptual studies of size and weight. In IEEE Winter Conference on Applications of Computer Vision, 2014). The reconstructed surface enables dense correspondence between co-visible regions in different images by back-projection. This is further validated with standard tools from multiple-view geometry by epipolar RANSAC. Occlusions are determined using the range map. Further implementation details are described in an article (J. Dong, N. Karianakis, D. Davis, J. Hernandez, J. Balzer, and S. Soatto. Multi-view feature engineering and learning. ArXiv preprint: 1311.6048, 2013.).

Detection and Tracking: We use FAST (E. Rosten and T. Drummond. Machine learning for high-speed corner detection. In Proceedings of European Conference on Computer Vision, volume 1, pages 430-443, May 2006) as a mechanism to (conservatively) eliminate regions that are expected to have non-discriminative descriptors, but this step could be forgone. Scale changes are handled in a discrete scale-space, for example images are downsampled by half up to 4 times and FAST is computed at each level. Short-baseline correspondence is established with standard MLK (B. D. Lucas, T. Kanade, et al. An iterative image registration technique with an application to stereo vision. In International Joint Conferences on Artificial Intelligence, volume 81, pages 674-679, 1981). A sequence of image locations is returned by the tracker for each region, which is then sampled in a rectangular neighborhood at the scale of the detector. We report experiments on two window sizes, 11×11 and 21×21, illustrative of a range of experiments conducted. The sequence of such windows is then used to compute the descriptors.

8.5. Evaluation and Comparison.

The following briefly describes the descriptors and classifiers involved in the evaluation and refers to the article (J. Dong, N. Karianakis, D. Davis, J. Hernandez, J. Balzer, and S. Soatto. Multi-view feature engineering and learning. ArXiv preprint: 1311.6048, 2013.) for the implementation details, parameter selections and training procedures.

Single-View Descriptors: We use SIFT as a baseline (SV-SIFT), computed on each patch at each frame as determined by the detector and tracker. We also compare single-view descriptor representatives DAISY (E. Tola, V. Lepetit, and P. Fua. Daisy: an efficient dense descriptor applied to wide-baseline stereo. IEEE Transactions on Pattern Analysis & Machine Intelligence, 32(5):815-830, 2010) and SURF-128 (H. Bay, T. Tuytelaars, and L. Van Gool. Surf: speeded up robust features. In Proceedings of European Conference on Computer Vision, pages 404-417. Springer, 2006) computed on the individual images.

Multiple-View Descriptors: MV-HoG is implemented according to Section 8.3.1 using the tracks returned by the MLK tracker. We also tested Random Forest (V. Lepetit, P. Lagger, and P. Fua. Randomized trees for real-time keypoint recognition. In Proceedings of IEEE Conference on Computer Vision & Pattern Recognition, volume 2, pages 775-781, 2005) as an alternative way of utilizing multiple samples. We present to the RFs the training samples, and refer to this as A-RF. Deformable parts models would be too slow to test on our dataset, so we forgo that comparison.

Reconstructive Descriptors: To compute an approximation of R-HoG in Section 8.3.2 we compute dense 3-D reconstructions both from some tracked sequences and using a structured-light sensor. Where visual reconstruction was successful, performance was similar, but dense reconstruction was laborious and the quality was not consistent across samples, so to make the evaluation independent of reconstruction methods, we report the results using a structured light sensor only. We use the keyframe where features are first extracted, and sample a viewing hemisphere with 576 vantage points. The R-HoG is built upon these synthesized samples. As in the multiple view case, we also feed synthesized patches to the Random Forest (R-RF).

Classifier and Strategies: Given a descriptor database, the simplest method to match a test query is via nearest neighbor (NN) search. We compare five combinations using the same NN search method: (i) single view SV-SIFT, SURF and DAISY—computed on a random image from the training sequence, (ii) Ave-SIFT (E. Delponte, N. Noceti, F. Odone, and A. Verri. The importance of continuous views for real-time 3d object recognition. In ICCV Workshop on 3D Representation for Recognition, 2007)—averaged SIFT of all frames, (iii) Orb-SIFT—all of the SV-SIFTs stored to represent the orbit which includes the best possible exemplar for each feature (M. Grabner and H. Bischof. Object recognition based on local feature trajectories. I cognitive vision works, 2, 2005), (iv) MV-HoG and (v) R-HoG.

Network Architecture: We also compare our methods with a simple network architecture in the form of a gated restricted Boltzmann machine (G-RBM), employed by the authors in correspondence tasks similar to those considered in this paper. We use the same matching strategy as Orb-SIFT, so we call the network Orb-GRBM. Details of the G-RBMs are in (J. Dong, N. Karianakis, D. Davis, J. Hernandez, J. Balzer, and S. Soatto. Multi-view feature engineering and learning. ArXiv preprint: 1311.6048, 2013).

8.5.1. Metrics.

We use precision-recall curves (PR-curves) to quantitatively evaluate the descriptors proposed and compare them to existing methods. For each query patch, nearest neighbor search returns a predicted label and its associated distance. By changing a distance thresh τd , a precision-recall curve can be generated. Precision and recall are defined as

$$p = \frac{\# true matches}{\# false matches + \# true matches} , \\ r = \frac{\# true matches}{\# positive samples} .$$

The “positive samples” are the test queries that have correspondences in the training databases as opposed to the “negative” samples which are never seen in training. The matches are the queries that pass the distance threshold test. A match is considered to be a “true match” if the predicted label is correct according to the ground truth. As only one predicted label is obtained for each query, r could remain less than 1 once any predicted label is wrong. We report the F1-score

$$( \frac{2 pr}{p + r} )$$

for each PR curve. Similarly, random forests (A-RF and R-RF) return an averaged probability as a confidence score for the predicted label. A precision-recall curve can be generated by changing a belief threshold τρ.

8.5.2. Empirical Results.

Qualitative results are shown in FIG. 16D and FIG. 16D and in the article (J. Dong, N. Karianakis, D. Davis, J. Hernandez, J. Balzer, and S. Soatto. Multi-view feature engineering and learning. ArXiv preprint: 1311.6048, 2013). In FIG. 17A through FIG. 17F, PR curves are shown for all the datasets on two different patch sizes. R-HoG and MV-HoG are comparable on 11×11 patches and outperform other methods. On 21×21 patches, the 3D-reconstruction generates artifacts in the view-set generation, so the performance of R-HoG decreases below that of MV-HoG in both the real and synthetic datasets. It should not be surprising that Orb-SIFT performs the best among all the other methods, as it entails exhaustive search over the orbit of transformed views. However, its precision drops sharply when the number of negatives is large, as it inherits the vulnerability of SV-SIFT to outliers. Also, MV-HoG is consistently better than Ave-SIFT across all datasets. Note that both involve averaging histograms, but Ave-SIFT averages normalized descriptors computed in each frame, and then re-normalized, whereas MV-HoG aggregates gradient orientation over time, and only normalizes the descriptor at the end, using the same procedure and clamping threshold as Ave-SIFT. This shows that temporal aggregation improves performance compared to simply averaging single-view descriptors computed independently.

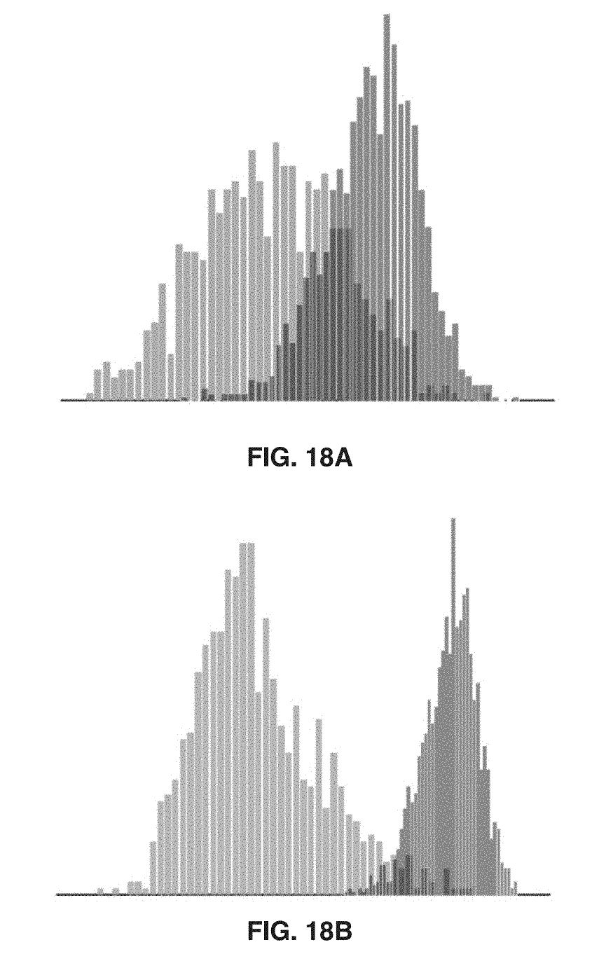

FIG. 18A and FIG. 18B shows the distance distributions between descriptors of corresponding and non-corresponding patches for SV-HoG in FIG. 18A, and for MV-HoG in FIG. 18B. In these plots, the horizontal axis indicates the distance between two descriptors in increasing order from left to right. The distribution of distances between corresponding features are shown in a first shade and that of mismatches in a second shade, with the error (overlapping area) in a third shade. It will be noted that the error in FIG. 18B is considerably smaller than FIG. 18A. This leads to a lower risk of misclassification in MV-HoG.

SV-HoG is computed from a random single sample from each track, and MV-HoG is aggregated over the whole track. The overlapping area between the two distributions indicates the probability of making a classification error in descriptor matching. These figures indicates that the discriminative power of the descriptor is improved by aggregating over multiple views.

8.5.3. Support Region, Spatial Aggregation, Sample Sufficiency and Complexity.

The size of the domain where descriptors are computed impacts performance (FIG. 17A through FIG. 17F): where larger domains results in increase performance so long as the domain remains co-visible (i.e., gₜ ∈ G₀).

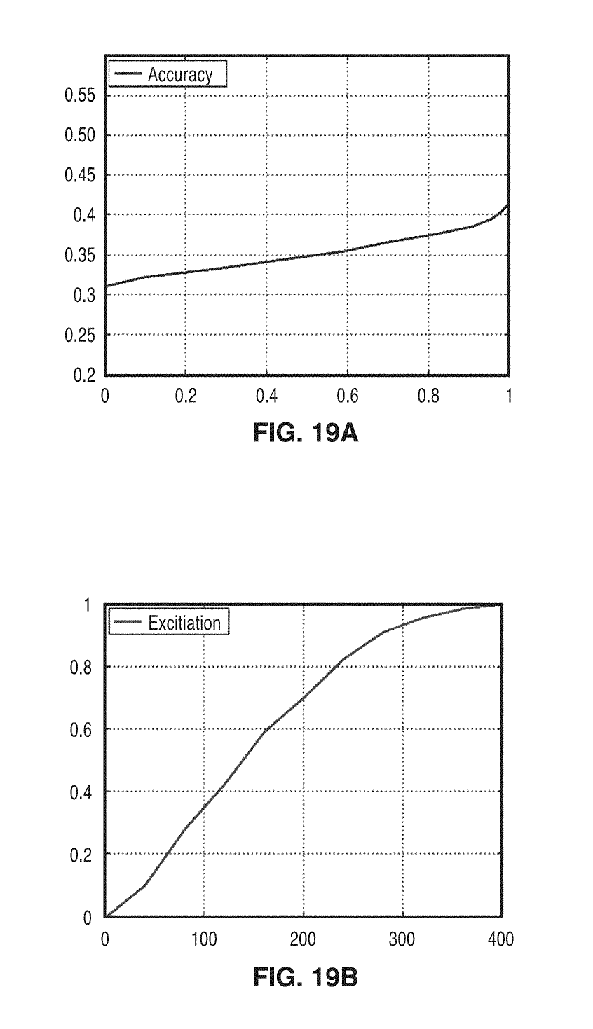

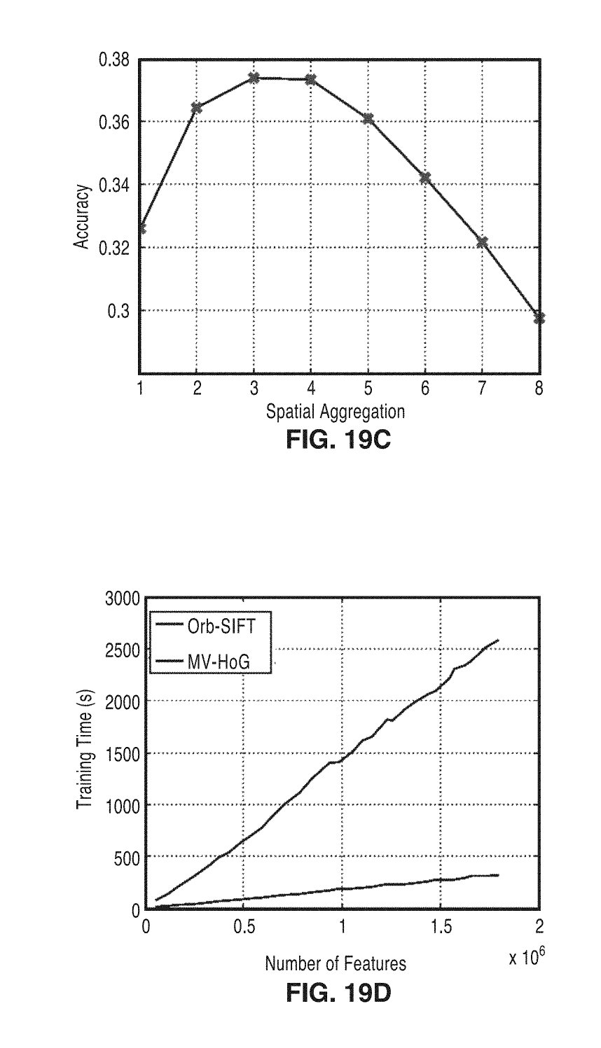

FIG. 19A through FIG. 19D illustrate accuracy, excitation, spatial aggregation and time complexity. In FIG. 19A accuracy is seen, for the sufficient excitation seen in FIG. 19B. Accuracy (maximum recall) is shown in FIG. 19A as a function of a proxy of sufficient excitation. In FIG. 19B excitation is seen as a function of the number of frames. All results are averaged over multiple runs using frames i, . . . , i+k-1 where i is selected at random. In FIG. 19C the F1-score is seen varying with spatial aggregation parameter σ. In FIG. 19D time complexity is seen as a function of the number of features with FLANN precision at 0.7. Higher precision will further increase computational load.

In FIG. 19C the effect of the spatial parameter σ in MV-HoG (Section 8.3.1) is seen. A slight spatial aggregation enhances robustness until σ reaches a critical value, beyond which discriminative power drops. Multiple view descriptors perform scene-dependent blurring, and therefore remain more discriminative, as long as sufficient excitation conditions are met. Clearly, if a sequence of identical patches is given (video with no motion), the descriptor will fail to capture the representative variability of images generated by the underlying scene. In this case, MV-HoG reduces to DSP-SIFT, which differs from SV-SIFT because of domain-size aggregation (averaging over σ). In FIG. 19A the relation between performance gain and excitation level of the training sequence was explored. As a proxy of the latter, we measure the variance of the intensity relative to the mean using the f2 distance. FIG. 19B shows that the variance reaches the maximum when most frames are seen. We normalize the variance so that 1 means maximum excitation. FIG. 19A shows accuracy increases with excitation. The fact that accuracy does not saturate is due to the fact that the sufficient excitation is only reachable asymptotically. At test time, all descriptors of n features have the same storage complexity O(n) except that Orb-SIFT stores every instance (O(kn)). The search can be performed in approximate form using approximate nearest neighbors as seen in the article (D. Davis, J. Balzer, and S. Soatto. Asymmetric sparse kernel approximations for nearest neighbor search. In Proceedings of IEEE Conference on Computer Vision & Pattern Recognition, Jun. 1, 2013). FIG. 19D shows the training time using the fast library for approximate nearest neighbors (FLANN) vs MV-HoG on a commodity PC with 8GB memory and Xeon E3-1200 processor. MV-HoG scales well and is more memory-efficient while Orb-SIFT requires more training time and occupies more than 60% of the available memory. Another advantage of MV-HoG is that the descriptor can be updated incrementally, and does not require storing processed samples.

8.6. Discussion.

By interpreting the SIFT/HOG family as the probability density of sample images conditioned on the underlying scene, with nuisances marginalized, and observing that a single image does not afford proper marginalization, we have been able to extend it using nuisance distributions learned from multiple training samples of the same underlying scene. The result is a multi-view extension of HoG that has the same memory and run-time complexity as its single-view counterpart, but better trades off sensitivity with discriminative power, as shown empirically, even with the classifier trivialized.

Our method has several limitations: It is restricted to static (or slowly-deforming) objects; it requires correspondence in multiple views to be assembled (although it reduces to DSP-SIFT if only one image is available), and is therefore sensitive to the performance of the tracking (MV-HoG) or reconstruction (R-HoG) algorithm. The former also requires sufficient excitation conditions to be satisfied, and the latter requires sufficiently informative data for multi-view stereo to operate, although if this is not the case (for instance in textureless scenes), then by definition the resulting descriptor is insensitive to nuisance factors; it is also, of course, uninformative, as it describes a constant image, and therefore this case is of no interest. It also requires the camera to be calibrated, but for the same reason, this is irrelevant as what matters is not that the reconstruction be correct in the Euclidean sense, but that it yields consistent reprojections.

Our empirical evaluation of R-HoG yields a performance upper bound, as we use a better approximation of the reconstruction (from a structured light sensor or ground truth) rather than multi-view stereo that, while possible, yielded inconsistent results across different samples. As the quality (and speed) of the latter improve, the difference between the two will shrink. We have also neglected the effects of sampling artifacts in the approximation of the ideal descriptor. However, in practice we have found them to be of second-order, compared to the approximation implicit in the spatial independence of the locally-aggregated histograms. Also, we wish to point out that ideal representations, in the sense of sufficient statistics that are (maximally) invariant, are not unique. However, they are equivalent from the informational standpoint. Analytical evaluation of our approach is forthcoming.

It should be appreciated that the recitation of the term “we” in the preceding material generally denotes actions carried out by an apparatus or system when performing the disclosed method.

The descriptor enhancements described in the presented technology can be readily implemented within various computer systems which are configured for image processing. It should also be appreciated that image processing functions are performing on a computing platform implemented to include one or more computer processor devices (e.g., CPU, microprocessor, microcontroller, computer enabled ASIC, etc.) and associated memory storing instructions (e.g., RAM, DRAM, NVRAM, FLASH, computer readable media, etc.) whereby programming (instructions) stored in the memory are executed on the processor to perform the steps of the various process methods described herein. In addition, the present disclosure can be utilized with convolutional neural networks (CNN) to enhance their operation.

The computer and memory devices were not depicted in the diagrams for the sake of simplicity of illustration, as one of ordinary skill in the art recognizes the use of computer devices for carrying out steps involved with image processing operations, including generating descriptors for image matching and other applications. The presented technology is non-limiting with regard to memory and computer-readable media, insofar as these are non-transitory, and thus not constituting a transitory electronic signal.

Embodiments of the present technology may be described herein with reference to flowchart illustrations of methods and systems according to embodiments of the technology, and/or procedures, algorithms, steps, operations, formulae, or other computational depictions, which may also be implemented as computer program products. In this regard, each block or step of a flowchart, and combinations of blocks (and/or steps) in a flowchart, as well as any procedure, algorithm, step, operation, formula, or computational depiction can be implemented by various means, such as hardware, firmware, and/or software including one or more computer program instructions embodied in computer-readable program code. As will be appreciated, any such computer program instructions may be executed by one or more computer processors, including without limitation a general purpose computer or special purpose computer, or other programmable processing apparatus to produce a machine, such that the computer program instructions which execute on the computer processor(s) or other programmable processing apparatus create means for implementing the function(s) specified.

Accordingly, blocks of the flowcharts, and procedures, algorithms, steps, operations, formulae, or computational depictions described herein support combinations of means for performing the specified function(s), combinations of steps for performing the specified function(s), and computer program instructions, such as embodied in computer-readable program code logic means, for performing the specified function(s). It will also be understood that each block of the flowchart illustrations, as well as any procedures, algorithms, steps, operations, formulae, or computational depictions and combinations thereof described herein, can be implemented by special purpose hardware-based computer systems which perform the specified function(s) or step(s), or combinations of special purpose hardware and computer-readable program code.

Furthermore, these computer program instructions, such as embodied in computer-readable program code, may also be stored in one or more computer-readable memory or memory devices that can direct a computer processor or other programmable processing apparatus to function in a particular manner, such that the instructions stored in the computer-readable memory or memory devices produce an article of manufacture including instruction means which implement the function specified in the block(s) of the flowchart(s). The computer program instructions may also be executed by a computer processor or other programmable processing apparatus to cause a series of operational steps to be performed on the computer processor or other programmable processing apparatus to produce a computer-implemented process such that the instructions which execute on the computer processor or other programmable processing apparatus provide steps for implementing the functions specified in the block(s) of the flowchart(s), procedure (s) algorithm(s), step(s), operation(s), formula(e), or computational depiction(s).

It will further be appreciated that the terms “programming” or “program executable” as used herein refer to one or more instructions that can be executed by one or more computer processors to perform one or more functions as described herein. The instructions can be embodied in software, in firmware, or in a combination of software and firmware. The instructions can be stored local to the device in non-transitory media, or can be stored remotely such as on a server, or all or a portion of the instructions can be stored locally and remotely. Instructions stored remotely can be downloaded (pushed) to the device by user initiation, or automatically based on one or more factors.

It will further be appreciated that as used herein, that the terms processor, computer processor, central processing unit (CPU), and computer are used synonymously to denote a device capable of executing the instructions and communicating with input/output interfaces and/or peripheral devices, and that the terms processor, computer processor, CPU, and computer are intended to encompass single or multiple devices, single core and multicore devices, and variations thereof.

From the description herein, it will be appreciated that that the present disclosure encompasses multiple embodiments which include, but are not limited to, the following:

1. An apparatus for determining a local image descriptor for detecting and describing local features in received images, comprising: (a) a computer processor configured for processing an image; and (b) a non-transitory computer-readable memory storing instructions executable by the computer processor; (c) wherein said instructions, when executed by the computer processor, perform steps comprising: (c)(i) pooling gradient orientations across different domain sizes; (c)(ii) rescaling different sized patches from the image; (c)(iii) determining gradient orientations pooled across locations and scales to generate histograms; and (c)(iv) concatenating gradient orientations into a descriptor.

2. The apparatus of any preceding embodiment, wherein said descriptor is compatible with scale-invariant feature transform (SIFT).

3. The apparatus of any preceding embodiment, wherein said apparatus is a modification of scale-invariant feature transform (SIFT) obtained by pooling gradient orientations across different domain sizes, also called scales, so that histograms are combined for images of different sizes and spatial locations, into said descriptor.

4. The apparatus of any preceding embodiment, wherein said instructions when executed by the computer processor are performed on a regularly sampled lattice.

5. The apparatus of any preceding embodiment, wherein said apparatus extends spatial pooling performed in scale-invariant feature transform (SIFT) from aggregating information from pixels near a point of interest into a histogram, to scale pooling, and in which information from re-scaling of a patch is also aggregated.

6. The apparatus of any preceding embodiment, wherein said apparatus for determining a local image descriptor is either based on scale-invariant feature transform (SIFT), supported on structured domains including DPMs, or in network architectures including convolutional neural networks and scattering networks

7. The apparatus of any preceding embodiment, wherein said descriptor is configured for improving matching performance in a group of applications consisting of content-based retrieval, visual recognition, augmented reality, and tracking.

8. The apparatus of any preceding embodiment, wherein said instructions when executed by the computer processor perform steps comprising determining octave level in a scale-space for each said descriptor based on utilizing an area of each selected and rectified maximally stable extremal region (MSER).

9. A method of extracting image features, comprising: (a) extending the spatial pooling performed in a scale-invariant feature transform (SIFT) method; (b) wherein said extending is performed by aggregating information from pixels near a point of interest into a histogram, to scale pooling; and (c) aggregating information from re-scaling of a patch.

10. A method of determining a local image descriptor for detecting and describing local features in received images, comprising: (a) pooling gradient orientations across different domain sizes; (b) rescaling different sizes patches from an image; (c) determining gradient orientations pooled across locations and scales; and (d) concatenating gradient orientations into a descriptor.

11. The method of any preceding embodiment, wherein said method of determining a local image descriptor is either based on scale-invariant feature transform (SIFT), supported on structured domains including DPMs, or in network architectures including convolutional neural networks and scattering networks

12. The method of any preceding embodiment, wherein said descriptor is configured for improving matching performance in a group of applications consisting of content-based retrieval, visual recognition, augmented reality, and tracking.

13. A method of quantifying how discriminative a descriptor is comprising: characterizing dependency of said descriptor on intrinsic properties of the scene, namely shape and reflectance.

14. The method of any preceding embodiment, wherein said characterizing of dependency, comprises: (a) instantiating marginalized likelihood as a maximal contrast-invariant that is also G-invariant using an LA model; (b) deriving a sampling approximation of marginalized likelihood in which a scene is replaced with a collection of images of it, captured from multiple viewpoints; and (c) deriving a point-estimate based approximation where the scene is replaced with a point estimate reconstructed from a finite sample.

Although the description herein contains many details, these should not be construed as limiting the scope of the disclosure but as merely providing illustrations of some of the presently preferred embodiments. Therefore, it will be appreciated that the scope of the disclosure fully encompasses other embodiments which may become obvious to those skilled in the art.

In the claims, reference to an element in the singular is not intended to mean “one and only one” unless explicitly so stated, but rather “one or more.” All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

TABLE 1
Summary of complexity (dimension) and
performance (mAP) for all descriptors

mAP

| Method | Dimension | Oxford | Fischer |
|---|---|---|---|
| SIFT | 128 | .2750 | .4532 |
| DSP-SIFT | 128 | .3936 | .5372 |
| CNN-L4-PS69 | 512 | .3059 | .4779 |
| SIFT-BOW | 2048 | .2062 | .3963 |
| CNN-L3-PS69 | 4096 | .3164 | .4858 |
| CNN-L3-PS91 | 8192 | .3068 | .5055 |
| SLS | 8256 | .3320 | .5135 |
| RAW-PATCH | 8281 | .1600 | .3479 |
| CNN-L3-PS91 | 9216 | .3056 | .4899 |

What is claimed is:

1. An apparatus for determining a local image descriptor for detecting and describing local features in received images, comprising:
(a) a computer processor configured for processing an image; and
(b) a non-transitory computer-readable memory storing instructions executable by the computer processor;
(c) wherein said instructions, when executed by the computer processor, perform steps comprising:
(i) pooling gradient orientations across different domain sizes;
(ii) rescaling different sized patches from the image;
(iii) determining gradient orientations pooled across locations and scales to generate histograms; and
(iv) concatenating gradient orientations into a descriptor.

2. The apparatus of claim 1, wherein said descriptor is compatible with scale-invariant feature transform (SIFT).

3. The apparatus of claim 1, wherein said apparatus is a modification of scale-invariant feature transform (SIFT) obtained by pooling gradient orientations across different domain sizes, also called scales, so that histograms are combined for images of different sizes and spatial locations, into said descriptor.

4. The apparatus of claim 1, wherein said instructions when executed by the computer processor are performed on a regularly sampled lattice.

5. The apparatus of claim 1, wherein said apparatus extends spatial pooling performed in scale-invariant feature transform (SIFT) from aggregating information from pixels near a point of interest into a histogram, to scale pooling, and in which information from re-scaling of a patch is also aggregated.

6. The apparatus of claim 1, wherein said apparatus for determining a local image descriptor is either based on scale-invariant feature transform (SIFT), supported on structured domains including DPMs, or in network architectures including convolutional neural networks and scattering networks

7. The apparatus of claim 1, wherein said descriptor is configured for improving matching performance in a group of applications consisting of content-based retrieval, visual recognition, augmented reality, and tracking.

8. The apparatus of claim 1, wherein said instructions when executed by the computer processor perform steps comprising determining octave level in a scale-space for each said descriptor based on utilizing an area of each selected and rectified maximally stable extremal region (MSER).

9. A method of extracting image features, comprising:
(a) extending the spatial pooling performed in a scale-invariant feature transform (SIFT) method;
(b) wherein said extending is performed by aggregating information from pixels near a point of interest into a histogram, to scale pooling; and
(c) aggregating information from re-scaling of a patch.

10. A method of determining a local image descriptor for detecting and describing local features in received images, comprising:
(a) pooling gradient orientations across different domain sizes;
(b) rescaling different sized patches from an image;
(c) determining gradient orientations pooled across locations and scales; and
(d) concatenating gradient orientations into a descriptor.

11. The method as recited in claim 10, wherein said method of determining a local image descriptor is either based on scale-invariant feature transform (SIFT), supported on structured domains including DPMs, or in network architectures including convolutional neural networks and scattering networks

12. The method as recited in claim 10, wherein said descriptor is configured for improving matching performance in a group of applications consisting of content-based retrieval, visual recognition, augmented reality, and tracking.

13. A method of quantifying how discriminative a descriptor is comprising: characterizing dependency of said descriptor on intrinsic properties of the scene, namely shape and reflectance.

14. The method as recited in claim 13, wherein said characterizing of dependency, comprises:
(a) instantiating marginalized likelihood as a maximal contrast-invariant that is also G-invariant using an LA model;
(b) deriving a sampling approximation of marginalized likelihood in which a scene is replaced with a collection of images of it, captured from multiple viewpoints; and
(c) derive a point-estimate based approximation where the scene is replaced with a point estimate reconstructed from a finite sample.
